(19) United States
(12) Patent Application Publication
(10) Pub. No.: US 2015/0379141 A1
(43) Pub. Date: Dec. 31, 2015

(54) AUTOMATED SEARCH ENGINE OPTIMIZATION

(71) Applicant: Mainwire, LLC., Panama City (PA)

(72) Inventors: Scott A. Stouffer, Sunnyvale, CA (US); Maura D. Stouffer, Sunnyvale, CA (US)

(21) Appl. No.: 14/753,619

(22) Filed: Jun. 29, 2015

Related U.S. Application Data
(60) Provisional application No. 62/019,080, filed on Jun. 30, 2014.

(51) Int. Cl. G06F 17/30

(52) U.S. Cl. CPC G06F 17/30867; G06F 17/3053; G06F 17/30011

(57) ABSTRACT

A search engine may rank a network document, such as a webpage or a website, based on a score of the network document for one or more search queries on the search engine. The ranking and/or score of a network document may be changed by making one or more modifications to the network document, such as metadata, context, content, and link structure, among numerous other modifications. Described herein is a system and method for generating recommendations for an optimized set of modifications to the network document.

### CROSS-REFERENCE TO RELATED APPLICATIONS

This application claims priority to U.S. provisional patent application Ser. No. 62/019,080, filed Jun. 30, 2014, entitled AUTOMATED SEARCH ENGINE OPTIMIZATION. The prior application is herein incorporated by reference in its entirety.

### FIELD OF ART

Aspects of the invention generally relate to analyzing a network document. More specifically, aspects of the invention provide methods and systems for evaluating a network document and providing transparency into the manner in which the network document is analyzed and scored by a search engine. Thus, a user may view and navigate a network document from the perspective of a search engine. Furthermore, the network document may be ranked among other network documents, and recommendations to improve the ranking of the network document may be provided to the user.

### BACKGROUND

Providing quality search results on a search engine can be a complex process. Analyzing a given document on a network such as the Internet to determine its relation to other documents on the network requires millions of calculations, with each calculation attempting to model human perception as a mathematical or logical formula. Because of this complexity, website and other network document owners, whose webpages and other documents are the subject of these calculations, are often unable to fully appreciate and understand how and why their webpages or network documents are scored by search engines. Without a clear understanding of the analysis and scoring mechanism, publishers of websites and other network documents might not be able to capitalize on the ability of search engines to attract users to their websites.

### BRIEF SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

According to some aspects of the present disclosure, a method, system, apparatus, and/or non-transitory computer-readable medium having instructions stored thereon that, when executed, may cause a computing device to receive a selection of a website comprising one or more network documents. The computing device may determine a search engine ranking for the one or more network documents relative to a plurality of other network documents, and the search engine ranking for the one or more network documents may be based on one or more search queries. The computing device may determine a plurality of sets of modifications to the one or more network documents for the selected website. The computing device may also determine a traffic potential for each of the plurality of sets of modifications to the one or more network documents. Based on the traffic potential for each of the plurality of sets of modifications, the computing device may generate a recommendation for a first set of modifications to the one or more network documents selected from the plurality of sets of modifications. The computing device may generate, for display on a display of a client device, the recommendation for the first set of modifications.

The computing device may receive a selection of the recommendation for the first set of modifications. Responsive to receiving the selection of the recommendation for the first set of modifications, the computing device may apply the first set of modifications to the one or more network documents to generate a modified one or more network documents. The modified one or more network documents may also be published. In some aspects, generating the recommendation for the first set of modifications to the one or more network documents may be based on a ratio of an increase in a traffic metric for the one or more network documents to a number of modifications to the one or more network documents in the first set of modifications.

Determining the traffic potential for each of the plurality of sets of modifications to the one or more network documents may comprises, for each of the plurality of sets of modifications, determining a first difference between a click through rate of the one or more network documents after applying the set of modifications to the one or more network documents and a click through rate of the one or more network documents before applying the set of modifications to the one or more network documents. Determining the traffic potential may also comprise determining a second difference between a query score of the one or more network documents after applying the set of modifications to the one or more network documents and a query score of the one or more network documents before applying the set of modifications to the one or more network documents. The traffic potential may be determined based on the first difference and the second difference.

Determining the traffic potential for each of the plurality of sets of modifications to the one or more network documents may comprise, for each of the plurality of sets of modifications, determining a search volume for the search query. The traffic potential may be determined based on the search volume for the search query. Additionally or alternatively, determining the traffic potential for each of the plurality of sets of modifications to the network documents may comprise, for each of the plurality of sets of modifications, receiving a user selection of a plurality of metrics for determining the traffic potential. The traffic potential may be determined based on the plurality of metrics.

According to some aspects of the present disclosure, a system, apparatus, non-transitory computer-readable medium, and/or method may comprise generating, by a computing device, a first score for a network document based on a search query. The computing device may determine a plurality of modifications to the network document to generate a modified network document. The computing device may generate a second score for the modified network document based on the search query. The computing device may determine a traffic potential for the modified network document relative to the network document based on the first score for the network document and the second score for the modified network document. The computing device may determine to recommend to a user the plurality of modifications to the network document based on the traffic potential for the modified network document relative to the network document.

The method may also comprise generating a displayable graphical user interface comprising an option to apply the plurality of modifications to the network document. A selection of the option to apply the plurality of modifications to the network document may be received. Responsive to receiving the selection of the option, the computing device may apply the plurality of modifications to the network document to generate the modified network document, and publishing the modified network document.

Determining the traffic potential for the modified network document may comprise determining, by the computing device, a first difference between a click through rate of the modified network document and a click through rate of the network document. Determining the traffic potential may also comprise determining, by the computing device, a second difference between the second score of the modified network document and the first score of the network document. The computing device may determine the traffic potential for the modified network document based on the first difference and the second difference. Additionally or alternatively, determining the traffic potential for the modified network document may comprise determining a search volume for the search query and determining the traffic potential for the modified network document based on the search volume for the search query.

The method may comprise determining, by the computing device, an expected traffic potential for the modified network document based on the traffic potential for the modified network document and a potential traffic loss for the modified network document relative to the network document. In some aspects, the search query may comprise a plurality of search queries, generating the first score may comprise generating the first score for the network document based on the plurality of search queries, and generating the second score may comprise generating the second score for the modified network document based on the plurality of search queries.

The first score may determine a ranking of the network document relative to a plurality of other network documents scored based on the search query. Alternatively, the first score may be based on a plurality of factors comprising two or more of the following factors: a metadata title, a metadata description, a metadata keyword, a context associated with the network document, content of the network document, and a link structure of the network document. The second score may be based on the same plurality of factors as the first score.

In some aspects, the computing device described herein may comprise an optimization server configured to execute a simulated search engine. The method may further comprise sending, by the optimization server and to a client device having a display, a graphical user interface comprising a recommendation to apply the plurality of modifications to the network document. The graphical user interface may be displayable on the display of the client device.

The search query may comprise a plurality of keywords, and the method may further comprise receiving user input of the plurality of keywords, a search engine platform, and weights for a plurality of ranking factors. The traffic potential may be determined based on the plurality of keywords, the search engine platform, and the weights for the plurality of ranking factors. The method may comprise generating a displayable graphical user interface comprising an actual link flow distribution for the network document and a target link flow distribution for the network document. In some aspects, the method may comprise generating a displayable graphical user interface comprising an estimate of a return on investment for the network document. In additional aspects, the method may comprise generating a displayable graphical user interface comprising a breakdown of factors used to determine the first score for the network document or the second score for the modified network document.

### BRIEF DESCRIPTION OF THE DRAWINGS

Certain embodiments are illustrated by way of example and not limited in the accompanying figures in which like reference numerals indicate similar elements and in which:

FIG. 1 illustrates a block diagram of an example communication network in which one or more embodiments may be implemented.

FIG. 2 illustrates a block diagram of an example computing environment in which one or more aspects described herein may operate.

FIG. 3 illustrates an example network diagram of optimization engines operating in a global environment according to one or more aspects described herein.

FIG. 4 illustrates a block diagram of an example optimization engine according to one or more aspects described herein.

FIG. 5 illustrates an example data flow for processing a search query according to one or more aspects described herein.

FIG. 6 illustrates an example method for determining one or more optimal changes to a network document according to one or more aspects described herein.

FIG. 7 illustrates an example interface for displaying search results according to one or more aspects described herein.

FIG. 8 illustrates an example interface for displaying estimates of actual traffic according to one or more aspects described herein.

FIG. 9 illustrates an example simulation for each webpage and query of possible ranking position changes that could occur according to one or more aspects described herein.

FIG. 10 illustrates an example calculation of a metric of traffic efficiency for a network document according to one or more aspects described herein.

FIG. 11 illustrates an example calculation of potential traffic loss for a network document according to one or more aspects described herein.

FIG. 12 illustrates an example interface for displaying expected traffic potentials according to one or more aspects described herein.

FIG. 13 illustrates another example interface for displaying expected traffic potentials according to one or more aspects described herein.

FIG. 14 illustrates an additional example interface for displaying expected traffic potentials according to one or more aspects described herein.

FIGS. 15A-B illustrate an example interface for displaying historic search result ranking changes according to one or more aspects described herein.

FIG. 16 illustrates another example interface for displaying historic search result ranking changes according to one or more aspects described herein.

FIG. 17 illustrates an example interface for displaying keywords at a particular ranking position according to one or more aspects described herein.

FIG. 18 illustrates an example interface for displaying a group of websites according to one or more aspects described herein.

FIG. 19 illustrates an example method for creating and generating alerts according to one or more aspects described herein.

FIG. 20 illustrates a block diagram of an example alert system according to aspects described herein.

FIG. 21 illustrates an example interface for a user to manage search queries according to one or more aspects described herein.

FIG. 22 illustrates an example interface for a user to manage overrides according to one or more aspects described herein.

FIG. 23 illustrates an example interface for displaying simulation statistics for a top optimization simulation according to one or more aspects described herein.

FIG. 24 illustrates an example interface for displaying recommendations for changes to a network document or website according to one or more aspects described herein.

FIG. 25 illustrates an example interface for displaying keyword setup according to one or more aspects described herein.

FIG. 26 illustrates an example interface for displaying website setup according to one or more aspects described herein.

FIG. 27 illustrates an example interface for displaying boost factors according to one or more aspects described herein.

FIG. 28 illustrates an example interface for displaying a combined website search according to one or more aspects described herein.

FIG. 29 illustrates an example interface for displaying website traffic share according to one or more aspects described herein.

FIG. 30 illustrates another example interface for displaying website traffic share according to one or more aspects described herein.

FIG. 31 illustrates an example interface for displaying link flow distribution according to one or more aspects described herein.

FIG. 32 illustrates an example interface for displaying webpage recommendations according to one or more aspects described herein.

FIG. 33 illustrates an example interface for displaying an estimate of return on investment for a website according to one or more aspects described herein.

FIG. 34 illustrates an example interface for displaying historical and/or current search rankings according to one or more aspects described herein.

FIG. 35 illustrates an example interface for displaying scoring details according to one or more aspects described herein.

One or more of the drawings include trademarks such as SEO Engine®, Link Flow®, Search Engine Optimization Engine®, and Market Brew™. Other trademarks may also appear in one or more drawings.

### DETAILED DESCRIPTION

In the following description of the various embodiments, reference is made to the accompanying drawings, which form a part hereof, and in which are shown by way of illustration various embodiments in which the invention may be practiced. It is to be understood that other embodiments may be utilized and structural and functional modifications may be made without departing from the scope of the present invention.

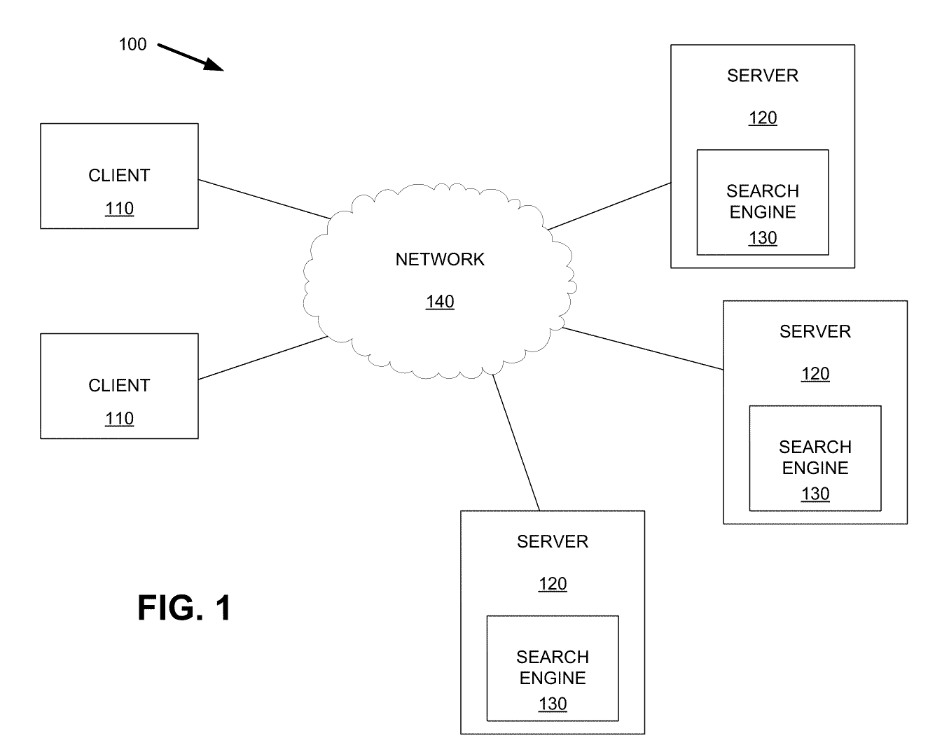

FIG. 1 illustrates a network environment 100 in which aspects described herein may be used. Environment 100 may include multiple client devices 110 connected to multiple servers 120 via a network 140. The network 140 may include wired or wireless connections and networks such as a local area network (LAN), a wide area network (WAN), a telephone network, such as the Public Switched Telephone Network (PSTN), an intranet, the Internet, or a combination of networks. Two client devices 110 and three servers 120 have been illustrated as connected to network 140 for simplicity. In practice, there may be more or fewer client devices and servers. Also, in some instances, a client device may perform the functions of a server and a server may perform the functions of a client device. The client devices 110 may include data processing machines, such as mainframes, minicomputers, personal computers, laptops, tablets, personal digital assistants, mobile phones or the like, capable of connecting to the network 140. The client devices 110 may transmit data over the network 140 or receive data from the network 140 via a wired, wireless, or optical connection.

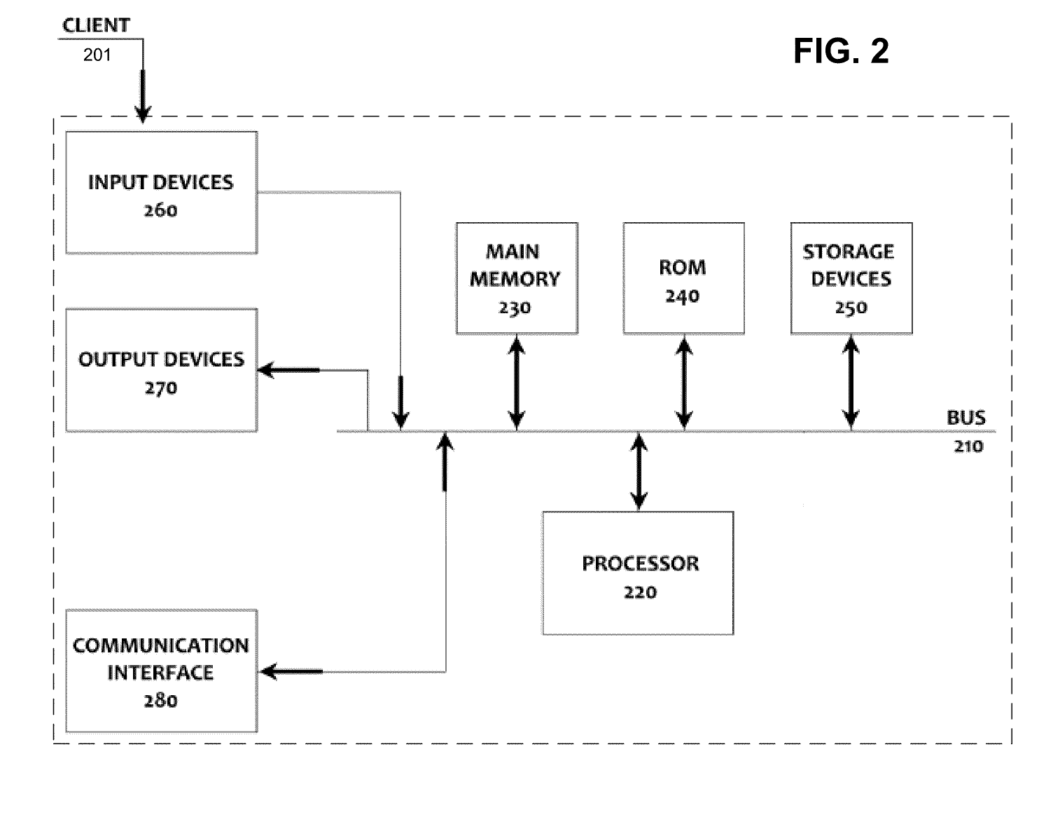

FIG. 2 illustrates an exemplary client device, e.g., device 110 of FIG. 1. The client device 201 may include a bus 210, a processor 220, a main memory 230, a read only memory (ROM) 240, a storage device 250, an input device 260, an output device 270, and a communication interface 280. The bus 210 may include one or more conventional buses that permit communication among the components of the client device 201. The processor 220 may include any type of conventional processor or microprocessor that interprets and executes instructions. The main memory 230 may include a random access memory (RAM) or another type of dynamic storage device that stores information and instructions for execution by the processor 220. The ROM 240 may include a conventional ROM device or another type of static storage device that stores static information and instructions for use by the processor 220. The storage device 250 may include a magnetic and/or optical recording medium and its corresponding drive. The input device 260 may include one or more conventional mechanisms that permit a user to input information to the client device 201, such as a keyboard, a mouse, a pen, voice recognition and/or biometric mechanisms, etc. The output device 270 may include one or more conventional mechanisms that output information to the user, including a display, a printer, a speaker, etc. The communication interface 280 may include any transceiver-like mechanism that enables the client device 201 to communicate with other devices and/or systems. For example, the communication interface 280 may include mechanisms for communicating with another device or system via a network, such as network 140 of FIG. 1.

As will be described in detail below, the client devices 201 may be configured to perform searching-related operations. The client devices 201 may perform these operations in response to processor 220 executing software instructions contained in one or more computer-readable media, such as memory 230. A computer-readable medium may be defined as one or more memory devices. The software instructions may be read into memory 230 from another computer-readable medium, such as the data storage device 250, or from another device via the communication interface 280. The software instructions contained in memory 230 causes processor 220 to perform search-related activities described below. Alternatively, hardwired circuitry (e.g., application specific integrated circuits) may be used in place of or in combination with software instructions. Thus, aspects described herein are not limited to any specific combination of hardware, firmware and/or software.

Referring again to FIG. 1, the servers 120 may include one or more types of computing devices such as a mainframe, a minicomputer, or a personal computer, capable of connecting to the network 140 and to communicate with the client devices 110. In alternative implementations, the servers 120 may include mechanisms for directly connecting to one or more client devices 110. The servers 120 may transmit data over network 140 or receive data from the network 140 via a wired, wireless, or optical connection. The servers may be configured in a manner similar to that described above in reference to FIG. 2. Additionally, the server 120 may include a search engine 130 usable by the client devices 110. The servers 120 may further store network documents such as webpages accessible by the client devices 110.

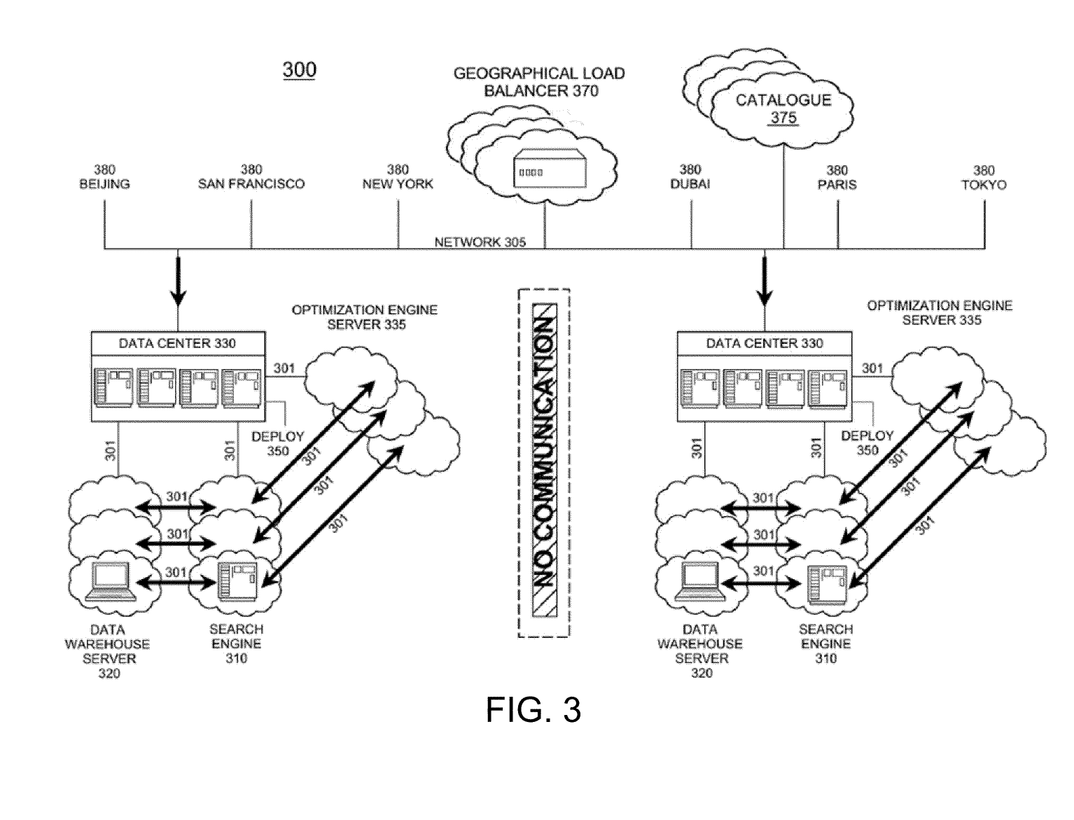

FIG. 3 illustrates a global network infrastructure having search engines and optimization engines (e.g., SEO Engine® (now Market Brew™) optimization engine). The global network infrastructure 300 includes network 305 (e.g., the Internet) that is configured to connect clients 380 located across multiple locations such as Beijing, San Francisco, New York, Dubai, Paris and Tokyo, to each other and to search engine data centers 330. A load balancer 370 may also be included in the network 305 to distribute search engine and/or data requests according to the relative processing loads of data centers 330. Each of search engine data centers 330 may include one or more servers and may be located in different geographic locations. For example, search engine data centers 330 may each include a data warehouse server 320 for storing copies of data from the network 305 (e.g., copies of websites and other network documents), a search engine server 310 for processing search queries and a search engine optimization server 335 configured to provide search engine optimization tools. Alternatively, each of servers 310, 320 and 335 may operate independently instead of in combination as a single data center. In independent operation, servers 310, 320 and 335 may still access services and/or data provided by each of the other servers through communication channels 301. For example, search engine optimization server 335 may request data from search engine server 310 to provide suggestions for improving a particular website or network document. A website, as used herein, generally refers to a grouping of any set of webpages and/or network documents. Accordingly, a website might not be limited to just a subdomain. In another example, search engine server 310 may access copies of network websites stored in data warehouse server 320 to provide search results in response to a query. Each data center indirectly communicates via the catalogue 375 to facilitate shared nothing architecture. Shared nothing architecture reduces the communications bandwidth needed for a massively parallel search engine. In particular, catalogue 375 may be configured to control which data center a user interacts with. Catalogue 375 may track which data center is responsible for which part of the Internet and may also be responsible and configured for storing user settings. Catalogue 375 may be configured to manage communications such as search queries or optimization requests from clients 380 and to distribute those requests to the appropriate server.

Each of search engine data centers 330 including servers 310, 320 and 335 may be controlled by a deployment infrastructure 350. In particular, deployment infrastructure 350 may be configured to manage software or firmware updates and may be responsible for configuring or upgrading servers. In one or more configurations, commands, requests and other communications may be received from client 380 via the network 305 on a proprietary communications channel (nonpublic). Additionally or alternatively, each of data centers 330 may operate independently of one another (i.e., without needing to communicate with each other) through the use of catalogue 375.

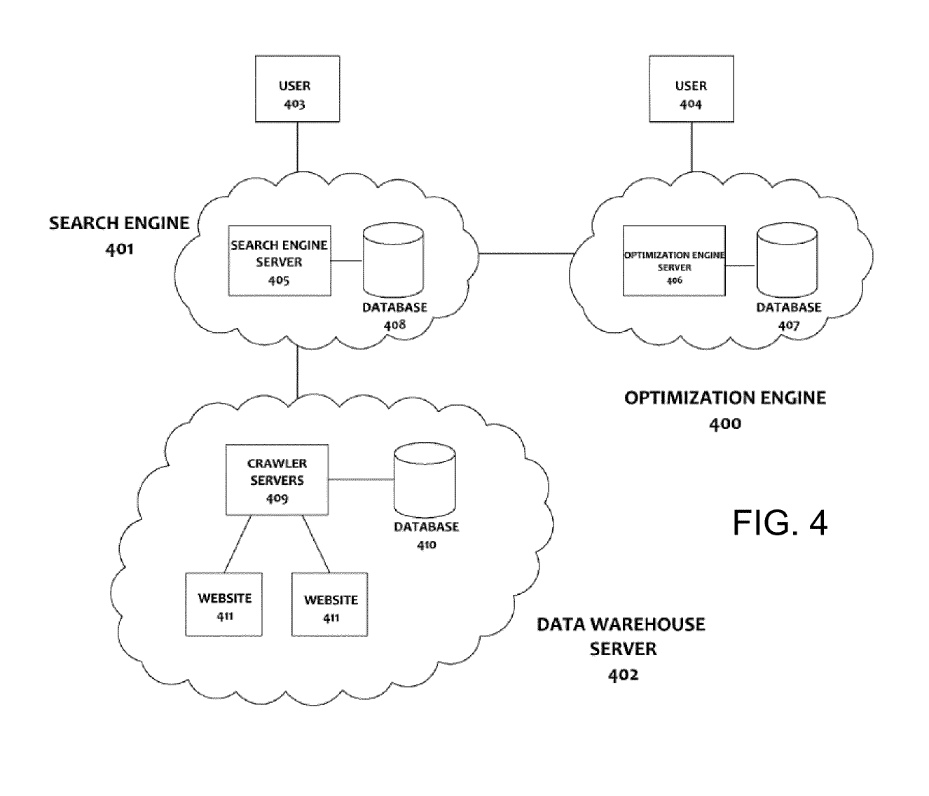

FIG. 4 illustrates a simplified block diagram of an example optimization engine operating environment. In the environment, optimization engine 400 includes a search engine optimization server 406 through which user 404 may interact with optimization engine 400, e.g., to specify a webpage, website, keyword(s) or link he or she wishes to explore. Optimization engine 400 may comprise a real-time interface which allows the user 404 to navigate the search engine 401 data and retrieve it on-demand. Optimization engine 400 may further be configured to generate suggestions, alerts, and to trigger re-crawls. The optimization engine server 406 may pass queries on to search engine 401 that retrieves information from database 408 as well as crawler servers 409. Search engine server 401 is configured and responsible for sorting, indexing, and scoring webpages. Search engine 400 may function with typical search engine behavior using the raw data from the data warehouse server 402. Optimization engine 400 is a cipher for search engine 401, allowing the user (e.g., user 404) to navigate the data stored in database 408 in a comprehensible and informative format. Database 407 may be configured to store historical information such as previous versions of websites, historical webpage statistics, other META data derived from search engine 401 and the like. Crawler servers 409 may be an automated module that is configured to crawl through web sites 411 and obtain relevant search engine data such as content and link information. Crawler servers 409 may be configured to crawl a network of websites or webpages on a predefined schedule or in an on-demand fashion or both. Results of the queries from user 404 or user 403 may be transmitted from search engine 401 to search engine optimization server 406 to generate results for the user's review and perusal. Accordingly, optimization engine 400 may decode or translate the data and processing performed by search engine 401 into user friendly information, statistics, recommendations and the like.

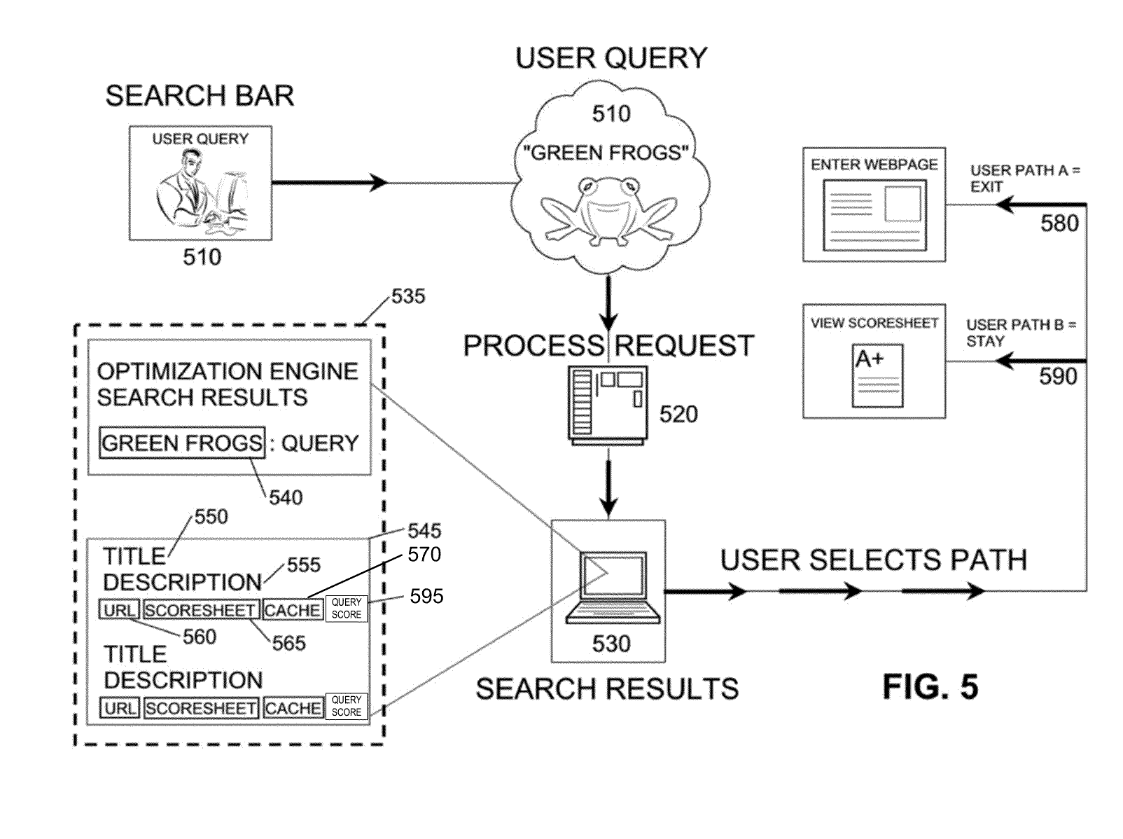

FIG. 5 illustrates a flow diagram for providing navigation into a search engine via search results. Initially, a user may enter 510 a search query such as a phrase. For example, the user query may be the phrase “green frogs.” The search query may then be processed 520 by a search engine to generate results that match or have some level of relevance to the specified query. Various methods for determining relevance of a webpage to a query may be used such as a query score 595. Once the search results have been generated, the results may be presented 530 to the user for review. In one arrangement, the search results may be displayed in results page 535. Results page 535 includes a search bar 540 indicating the search phrase or query that was specified. In addition, page 535 includes a results listing 545 in which each result is identified by a title 550, a description 555, a uniform resource identifier (URI) 560 such as a URL, an optimization engine scoresheet 565, a cache option 570, and a query score 595. Cache option 570 allows a user to retrieve a webpage or network document that was previously cached on a specified date and at a specified time (i.e., versus retrieving the live or current webpage or network document). Using the cache option 570 may be quicker because the search engine might not need to query the actual website for the newest data. To enter the website 580, a user may select the title 550, the description 555 or the uniform resource identifier 560. Alternatively, if the user wishes to view 590 an optimization engine scoresheet of the website, the user may select scoresheet option 565. Results page 535 is but an example of how a results listing may be presented and is not intended to limit the possible configurations of result pages.

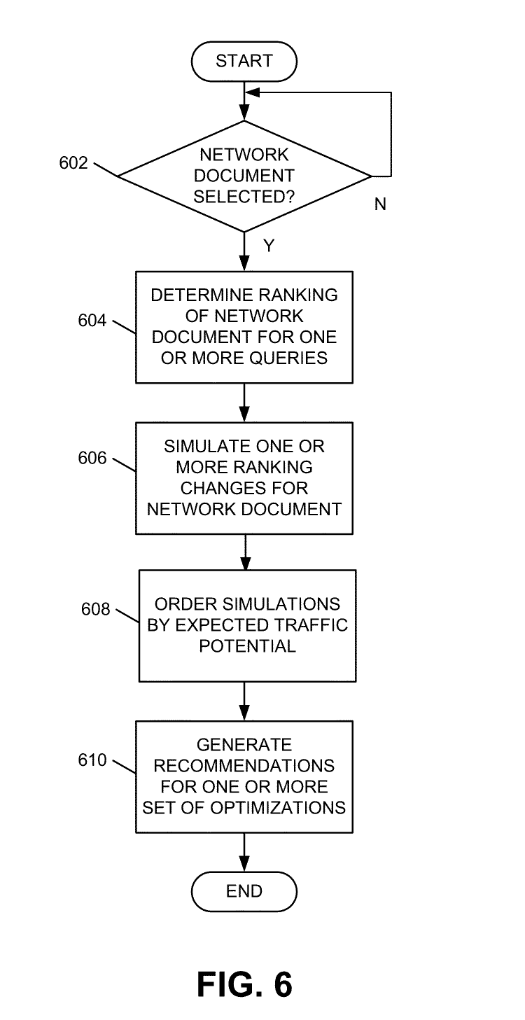

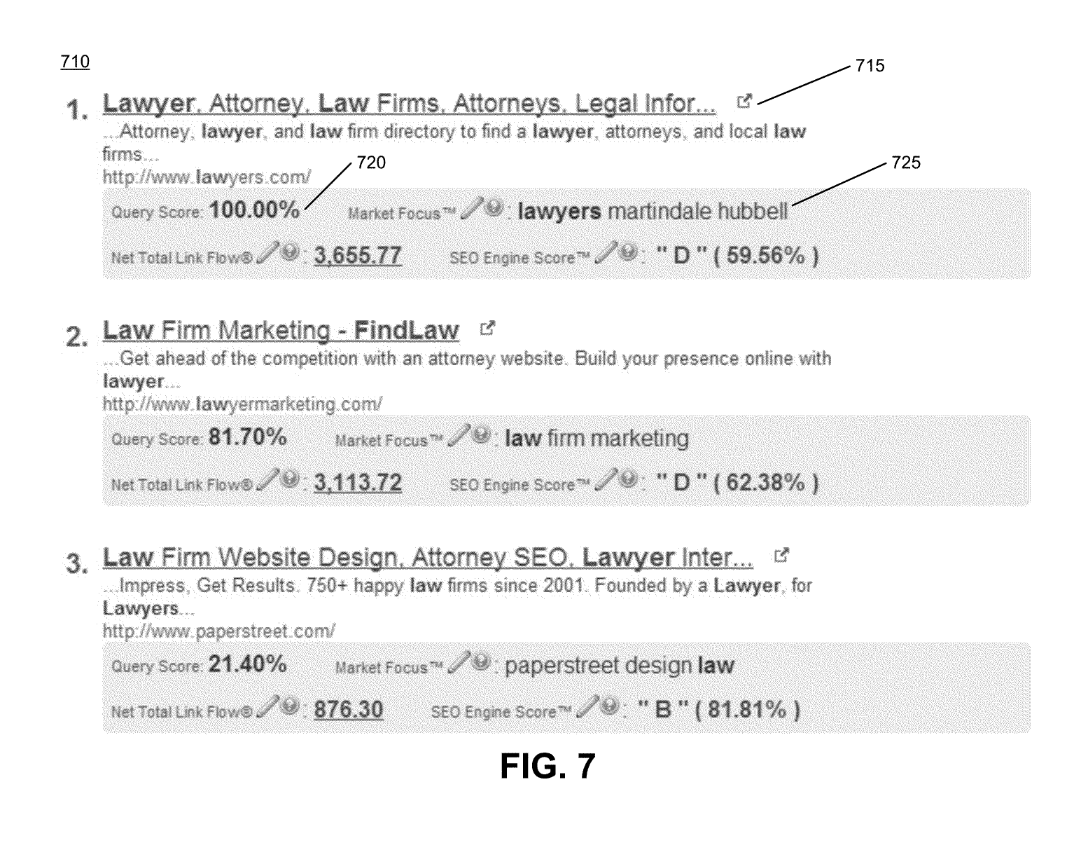

FIG. 6 illustrates an example method for determining one or more optimal changes to a network document according to one or more aspects described herein. In step 602, a computing device may determine whether a network document has been selected, such as by a user or selected automatically. For example, the user may select a network document to optimize. If a network document has not been selected (step 602: N), the computing device may wait for a network document to be selected. If a network document has been selected (step 602: Y), the computing device, in step 604, may determine the ranking of the network document for one or more queries. Determining the rankings will be described in further detail in the examples that follow, including with reference to FIG. 7.

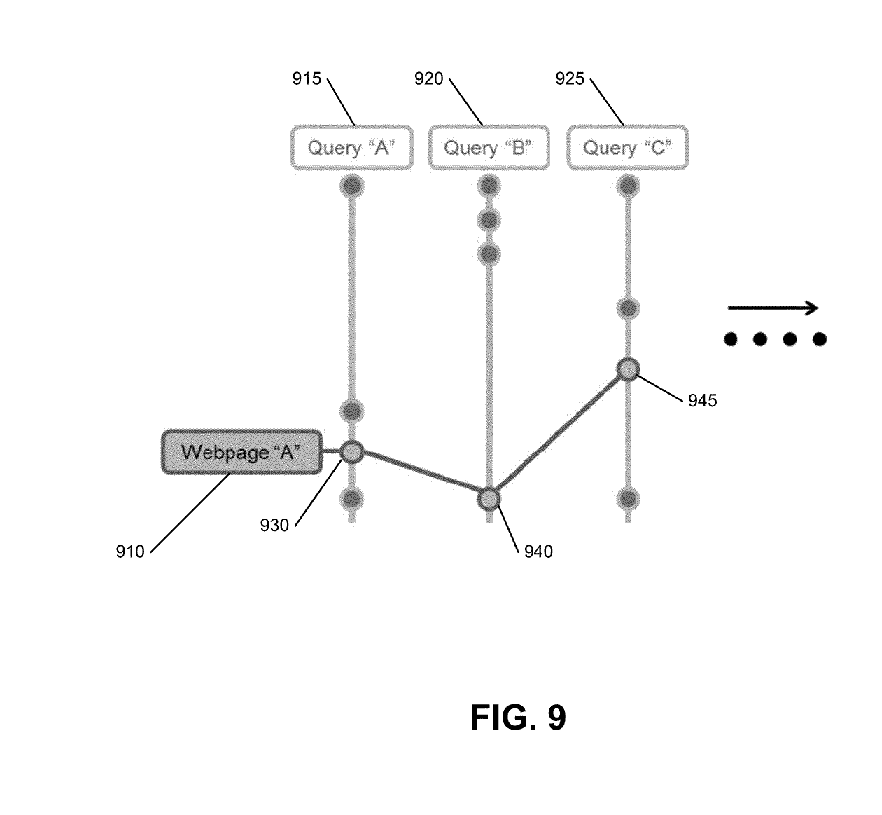

In step 606, the computing device may simulate one or more ranking changes for the network document. For example, the computing device may apply one or more changes to the network document (e.g., adjusting link text size, anchor text size, etc.) and determine a new ranking for the network document. This process may be repeated multiple times for different sets of network document changes. Simulating ranking changes will be described in further detail in the examples that follow, including with reference to FIGS. 9-11.

In step 608, the computing device may order the simulations by expected traffic potential. The expected traffic potential may measure the level of efficiency of a particular set of changes to the network document. In particular, the expected traffic potential may be used to identify the optimal changes (e.g., the least amount of changes for the greatest gain in traffic). Calculating and ordering the expected traffic potential will be described in further detail in the examples that follow, including with reference to FIGS. 9-12.

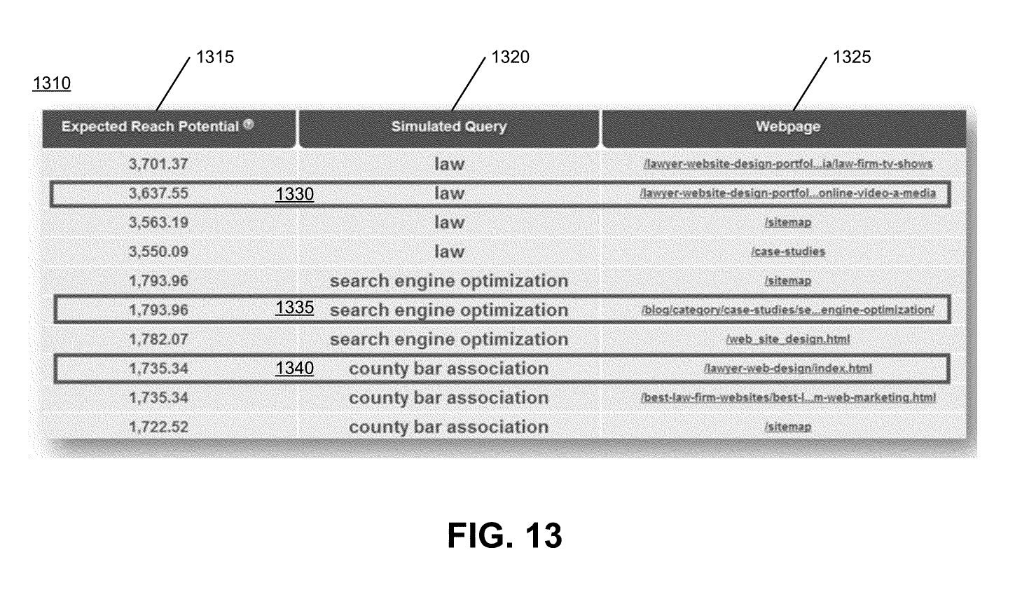

In step 610, the computing device may generate recommendations for one or more sets of optimizations (e.g., changes to the network document). The recommendations may factor in the expected traffic potential calculated in step 608, the user's preferred change types (e.g., content-based changes or link-based changes), and the effect of changes on other webpages. Generating recommendations will be described in further detail in the examples that follow, including with reference to FIG. 13.

FIG. 7 illustrates an example interface 710 for displaying search results according to one or more aspects described herein. A score, such as a query score 720, may be displayed for each search result. A computing device may determine the score 720 for each search result based on one or more factors. For example, the score 720 may be derived by adding together a total LINK FLOW of the webpage multiplied by 100 and the penalty factor (the penalty factor being negative). The percentages may be calculated based on a maximum score, penalty factor and total LINK FLOW. Other exemplary, non-limiting factors for determining the query score 720 include the content matching of the network document, the META title relevancy, the META description relevancy, the META keyword relevancy, other metadata for the network document, the MARKET FOCUS relevancy, the content matching of the Uniform Resource Locator (URL) of the network document, and/or the NET TOTAL LINK FLOW of the network document, among numerous other factors as described in U.S. Pat. No. 8,447,751 entitled “Navigable Website Analysis Engine,” which is hereby incorporated by reference in its entirety.

A META title refers to the text that a user will see at the top of a web browser for a given webpage or network document. Typically, a META title is defined in HTML using the <title> </title> tags. META descriptions, on the other hand, refer to words, phrases and descriptions that define the content of the underlying webpage or network document. Using HTML, META descriptions may be specified as follows: <META NAME=“Description” CONTENT=“description”>. META keywords correspond to terms describing the theme or context of the webpage or network document. Using HTML, META keywords may be specified as follows: <META NAME=“keywords” CONTENT=“keywords”>. META title, META description, and META keyword are described in further detail in U.S. Pat. No. 8,447,751.

The MARKET FOCUS 725 may relate to the grouping of categories or contexts associated with the network document. In some aspects, the MARKET FOCUS 725 may be determined by the search engine. A MARKET FOCUS RANK may be calculated using a shingle analysis which includes considerations of content on the network document, META title, META descriptions, and incoming anchor text, as described in further detail in U.S. Pat. No. 8,447,751. The MARKET FOCUS 725 may also be displayed in the search result listing with the corresponding search result, as illustrated in FIG. 7.

One or more of the factors described herein may be combined to generate a combined score, such as a query score 720 as illustrated in FIG. 7. Furthermore, the computing device may give greater weight to one or more of the factors and lesser weight to one or more of the other factors to generate the overall (combined) score.

The search results may be ranked according to their scores. In the example search result listing of FIG. 7, the highest ranked website 715 (e.g., “http://www.lawyers.com/”) may have a query score 720 of 100.00%. The second ranked website (e.g., “http://www.lawyermarketing.com/”) may have a query score of 81.70%. The third ranked website (e.g., “http://www.paperstreet.com/”) may have a query score of 21.40%. Accordingly, a user may see the order of the search results for a particular query, along with the distances (e.g., difference between query scores) between those search results. The user may also drill down to determine how the query score was calculated by the search engine, as described in further detail in U.S. Pat. No. 8,447,751.

Other factors that may be considered in determining a ranking of a webpage, a website or a link may include reverse redirect information (i.e., which webpages are being redirected to a webpage), forward redirect information (i.e., which webpages are being redirected to from a given webpage, total or alternative search volume by MARKET FOCUS (i.e., how many people on the Internet or the network are searching for a given webpage or website), age of website, statistical deviation analysis of external incoming anchor text (i.e., analysis of differences in text being used to link to a particular webpage/website), purchased or relevant link detection (i.e., links being used to subvert a search engine's algorithms), and/or unnatural keyword stuffing (i.e., use of keywords or phrases to subvert a search engine's algorithms), as described in further detail in U.S. Pat. No. 8,447,751.

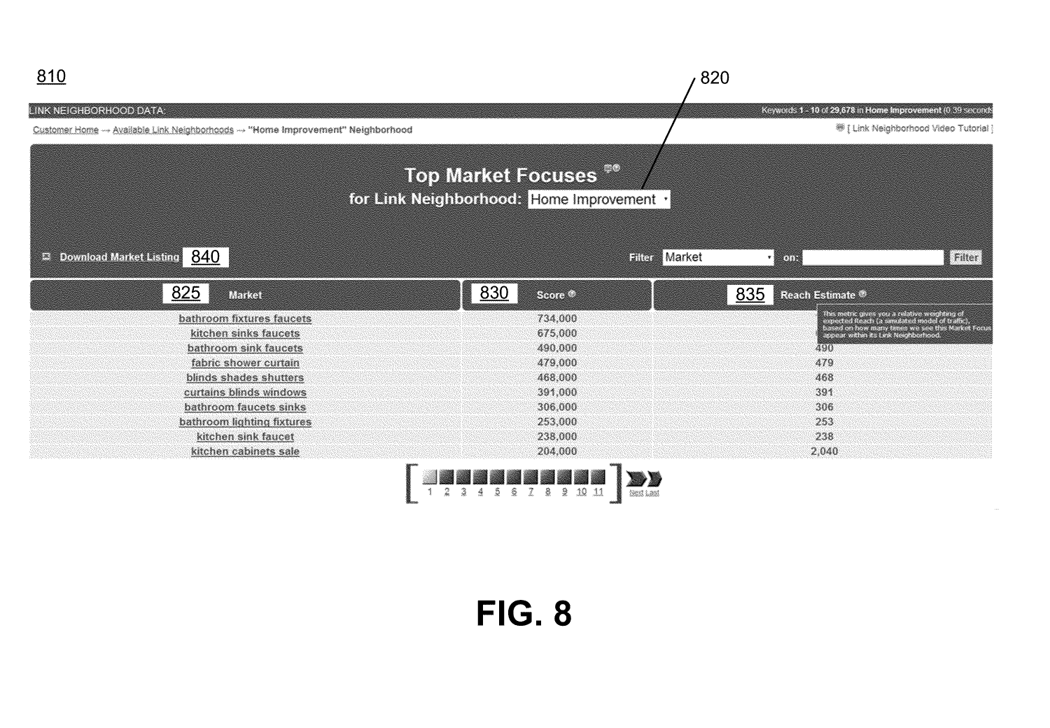

FIG. 8 illustrates an example interface 810 for displaying estimates of actual traffic (e.g., REACH) according to one or more aspects described herein. The REACH of a network document (e.g., a particular webpage or website) may identify the forecasted traffic to the network document. In other words, the REACH may be a traffic metric that describes an expected traffic value of the network document before it actually occurs. The REACH estimate metric 835 illustrated in FIG. 8 may give the user a relative weighting of expected REACH (a simulated model of traffic), based on how many times each particular MARKET FOCUS (or meaning) appears on the Internet.

Using the optimization engine, a user or computing device may take steps to automatically determine one or more optimal set of changes to a network document that results in a particular amount of REACH (e.g., a REACH greater than a predetermined threshold REACH or a maximum amount of REACH increase) with a particular number of changes to the network document (e.g., less than a predetermined threshold number or amount of changes or the fewest amount of changes), as will be described in further detail in the examples below.

The interface 810 may display a plurality of markets in the market listing 825, such as “bathroom fixtures faucets,” “kitchen sinks faucets,” “bathroom sink faucets,” and the like. The markets listed in the listing 825 may comprise the top X (e.g., top 10, top 50, etc.) markets in a particular grouping of contexts (e.g., LINK NEIGHBORHOOD), such as a Home Improvement grouping 820. The interface 810 may also display a score 830 for each market, and the markets may be ordered by its respective score 830. The score 830 for each market may be based on the keyword relevancy and the number of times it appears throughout the particular grouping of context(s), such as the Home Improvement context 820. As described above, the interface 810 may also display the REACH estimate 835 for each market 825. The interface 810 may also display an option 840 for the user to download a market listing including corresponding scores and/or reach estimates, such as in a spreadsheet or other format. In some aspects, the REACH estimate may comprise a search traffic volume for a keyword. The search traffic volume may be obtained directly from the search engine or a third party that provides this information specific to the search engine environment being simulated. This metric may be delivered directly into the optimization engine via an API query, to be factored into calculations. As will be described in further detail below, a user may provide one or more overrides which may affect how the REACH estimate is defined.

FIG. 9 illustrates an example simulation for each webpage and query of possible ranking position changes that could occur according to one or more aspects described herein. The computing device may simulate changes in the ranking of the network document (e.g., webpage A (910)) for one or more search queries, such as query A (915), query B (920), query C (925), and so on. As illustrated in FIG. 9, webpage A (910) may be ranked third (930) for query A (915), fourth (940) for query B (920), and third (945) for query C (925). While three queries are illustrated in FIG. 9, rankings for any number of queries may be determined for webpage A (910). Furthermore, the computing device may calculate the difference in scores (e.g., distance) between each of the search results for a particular query. As explained above, the rankings illustrated in FIG. 9 may be based on, for example, the query score for each network document. A network document with a higher score may be ranked higher than a network document with a lower score. The difference in scores may comprise the difference between query scores. The computing device may perform the same simulation using the same search queries for other network documents (e.g., webpage B, webpage C, and so on).

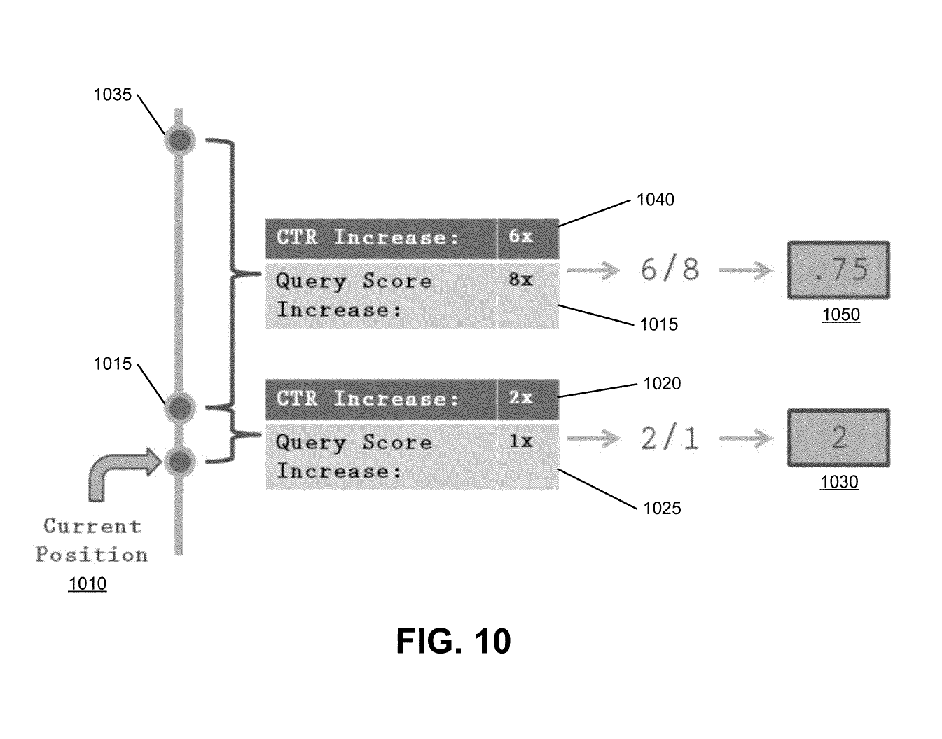

FIG. 10 illustrates an example calculation of a metric of traffic efficiency (e.g., a REACH potential) for a network document according to one or more aspects described herein. A traffic efficiency value may be determined for each simulated ranking change of the network document. The traffic efficiency may allow the user to see how much the network document stands to gain in terms of traffic potential (e.g., increase in click through rate) versus how much the score, such as the query score, of the network document must be increased (e.g., cost) in order to gain the additional traffic potential.

The network document score may be adjusted by changing one or more characteristics of the network document. Characteristics that may be changed are described in further detail in U.S. Pat. No. 8,447,751. Example changes include, but are not limited to, changing:
the number of documents in a website
the number of HTML webpages in a website
the number of irrelevant webpages in a website (e.g., a webpage may be considered irrelevant if the webpage does not have a sufficiently high webpage score)
the number of orphaned webpages in a website (e.g., orphaned webpages may refer to webpages or network documents to which an external (i.e., not in the same website) incoming link points, but which is not referred to by a webpage of the website in which the webpage exists. Thus, a user may be able to navigate to the webpage from an external website, but not from the website in which it is actually stored.)
the number of missing META titles in a website
the number of missing META description in a website
the number of META keywords in a website
the number of duplicate META titles in a website
the number of duplicate META descriptions in a website
the number of duplicate META keywords in a website
the number of duplicate MARKET FOCUS in a website
the number of duplicate URL spellings in a website
the number of exact duplicate webpages in a website
the number of outgoing links in a website (e.g., outgoing links may refer to links that are directed to other webpages (i.e., not a link within the webpage))
the number of external outgoing links in a website (e.g., the number of external outgoing links may refer to the number of links to webpages outside of the website)
the number of internal outgoing links in a website (e.g., the number of internal outgoing links may refer to the number of links directed to webpages within the web site)
the number of incoming links in a website (e.g., the number of incoming links may refer to the total number of links from other pages and websites to pages in the website)
the number of external incoming links in a website (e.g., the number of external incoming links may refer to the number of links from other websites to pages in the website)
the number of internal incoming links in a website (e.g., the number of internal incoming links may refer to the number of links from pages in the website to other pages in the website)
the number of broken links in a website (e.g., links that do not lead to a valid destination)
the number of dangling links in a website (e.g., links to non-indexable or webpages that do not have any followable links)
the number of nofollow links in a website (e.g., links tagged with the rel=nofollow attribute)
the number of non-editorial links in a website (e.g., links that were not mentioned in the context of writing about a particular subject matter that was of importance to the webpage being linked to)
the average LINK FLOW of external webpages linking to a website
the average LINK FLOW of external webpages linked from a website
a website's total internal incoming LINK LOSS (e.g., LINK LOSS may refer to a condition which is caused by inefficient linking. Factors contributing to a LINK LOSS score include external outgoing links, dangling links and orphaned webpages. External LINK LOSS may refer to LINK FLOW that is being sent out to other websites while internal LINK LOSS may comprise LINK FLOW that is not being preserved in a website due to its internal linking structure. For websites, total internal LINK LOSS may be calculated by subtracting the total internal LINK FLOW from the maximum theoretical total LINK FLOW, which is, in turn, determined by the formula 1 * the number of webpages in that website or set of webpages.)
a website's total external incoming LINK LOSS
a website's total external outgoing LINK LOSS
a website's total LINK LOSS
a response time of webpages in a website
the LINK FLOW distribution of a webpage in a website (e.g., the set of transition probabilities or adjacency functions of a random surfer as determined using node ranking, as described in U.S. Pat. No. 8,447,751 and incorporated herein by reference)
the NET LINK FLOW share of a link
the anchor text size of a link
the font size of a link
the Search Engine score of a website
the Search Engine penalties of a website
a website's content type or encoding type

The traffic (or REACH) potential (RP) for a particular search query may be calculated using the following algorithm:

$$RP ( x , t ) = K * \frac{{CTR}_{t} - {CTR}_{x}}{{QS}_{t} - {QS}_{x}}$$

“x” may represent the current ranking or position of the network document, and “t” may represent the improved ranking or position of the network document. CTRₓ may represent the click through rate of the network document at the current position, and CTRₜ may represent the click through rate of the network document at the improved position. QSₓ may represent the query score of the network document (or other score used to determine rankings) at the current position, and QSₜ may represent the query score (or other score) of the network document at the improved position. As previously discussed, the query score may be replaced with any other score, such as a search engine optimization score, a META title relevancy score, a MARKET FOCUS relevancy score, and the like. K may represent a weight, such as an estimated or actual search volume or amount of traffic, applied to the algorithm. For example, the actual search volume may comprise the actual amount of traffic that a search engine receives for a particular query. The actual search volume may be provided directly from the search engine or a third party that provides search engine data.

FIG. 10 illustrates two applications of the traffic potential algorithm for a network document at its current position (e.g., ranking) 1010. For these examples, assume that the weight K is 1. An increase from the current position 1010 to the second position 1015 may result in a CTR increase of 2 (1020) and a query score increase of 1 (1025). Accordingly, the traffic potential 1030 for an increase from the current position 1010 to the second position may be 2/1 (or 2). An increase from the current position 1010 to the third position 1035 may result in a CTR increase of 6 (1040) and a query score increase of 8 (1015). Accordingly, the traffic potential 1050 for an increase from the current position 1010 to the third position 1035 may be 6/8 (or 0.75). In some aspects, the more changes made to a network document (e.g., changes recommended by a computing device), the greater the query score of the network document may increase. Accordingly, the query score increase may represent the amount of effort used to improve the ranking of a network document. Although two examples are provided in FIG. 10, the computing device may determine the traffic potential for any combination of changes to the network document. Furthermore, the computing device may determine traffic potentials for multiple search queries in the same manner.

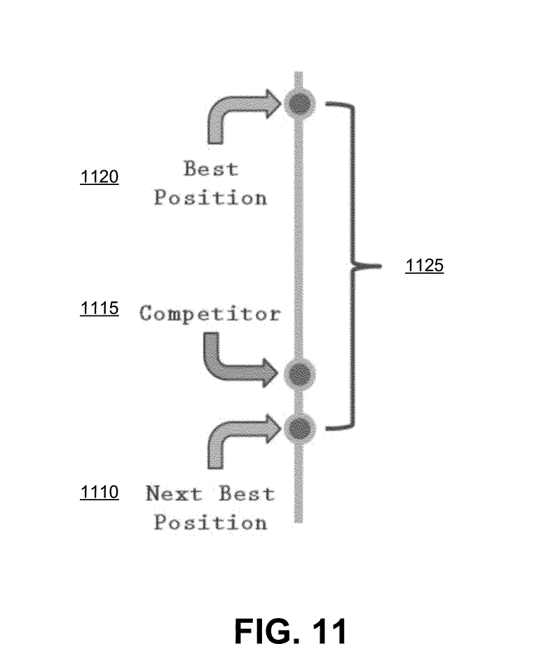

FIG. 11 illustrates an example calculation of potential traffic (e.g., REACH) loss 1125 for a network document according to one or more aspects described herein. The computing device may take into account any negative side effects of a particular ranking change (e.g., caused by change(s) to the network document) on the overall traffic to the network document. In other words, for each search query, the computing device may simulate every possible scenario (or some of the possible scenarios) in which a given network document ranking could be lowered, and how much potential traffic loss that means.

Taking the estimated search volume (or other variable) K for a given query and the click through rate (CTR_{w}) for a position 1120 occupied by a webpage w, the computing device may remove the webpage w occupying a current position x (1120) and rely on the next best network document 1110 in the website to rank. If x is the current position 1120 and t is the new (lower position) 1110 of the next best network document, the potential traffic (REACH) loss (PRL) 1125 for a particular search query may be calculated using the following algorithm:

PRL(x,t)=K*(CTRₓ−CTRₜ)

The position 1115 of a competitor's network document may also be identified. The competitor's network document may be manually identified by the user (e.g., by input of, for example, a URL, of one or more of the competitor's network documents). After the computing device has calculated the traffic potential (RP) and potential traffic loss (PRL) 1125, the computing device can combine the two metrics for one or more of the simulations, for a specific query, into a statistical expected traffic (REACH) potential (ERP). The expected traffic potential (ERP) may be calculated using the following algorithm:

$$ERP = {\sum }_{i = 1}^{S} ( K * \frac{1}{S} * \frac{RP}{PRL} ) = {\sum }_{i = 1}^{S} ( \frac{K * RP}{S * PRL} )$$

As previously discussed, K may represent the estimated search volume for a given query, RP may represent the traffic potential of the network document being simulated, and PRL may represent the potential traffic loss PRL of the network document being simulated. S may represent the total number of simulations S of all possible (or some of the possible) ranking changes. The expected traffic potential may be calculated for each combination of simulated query and network document simulated, as will be described in additional detail in the examples below.

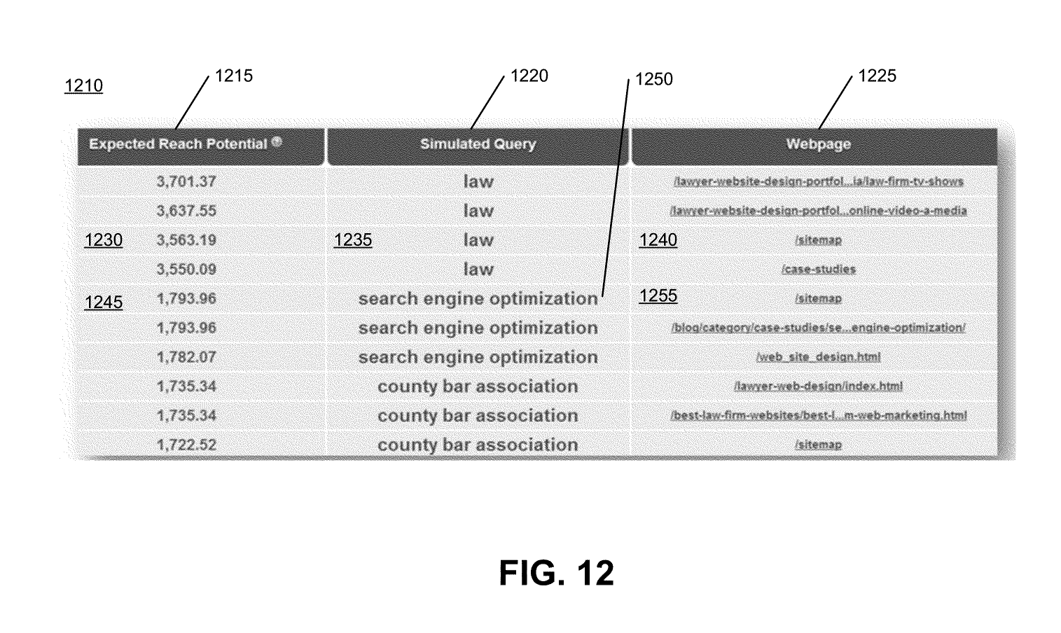

FIG. 12 illustrates an example interface 1210 for displaying expected (or forecasted) traffic potentials 1215 according to one or more aspects described herein. As illustrated, the computing device may calculate the expected traffic potential 1215 (e.g., ERP) for one or more network document (e.g., webpage) 1225 based on one or more queries (e.g., simulated queries) 1220. In particular, the computing device may calculate the ERP based on the algorithms described above. For example, the calculated expected traffic potential 1230 for the webpage 1240 ending in “/sitemap” and the query 1235 “law” may be 3,563.19. The calculated expected traffic potential 1245 for the same webpage 1255, but with the query 1250 “search engine optimization” may be 1,793.96. In some aspects, the computing device may order the ranking simulations by their expected traffic potential scores 1215. Thus, the user may be presented with the most efficient and least risky ranking changes for a given network document (e.g., at the top of the listing 1215). Each row in FIG. 12 may represent a potential ranking change, due to a set of optimizations that may be applied to that network document. As previously discussed, example optimizations include, for example, changing the content or link structure around that network document. The webpages 1225 displayed on the interface 1210 may comprise all of the webpages 1225 for a particular website or some of the webpages 1225 for that website.

In some aspects, the computing device may provide an option for the user to select the set of network document changes with the highest expected traffic potential (or any of the other changes). The computing device may then apply these changes to the network document and/or publish the new network document comprising the changes. Additionally or alternatively, the computing device may generate recommendations for one or more sets of network document changes based on numerous factors, including the user's preferences and/or the effect of the network document changes on other network documents, as will be described in further detail in the examples below.

FIG. 13 illustrates another example interface 1310 for displaying expected traffic potentials 1315 according to one or more aspects described herein. The interface 1310 may be the same as interface 1210 illustrated in FIG. 12, except that the computing device may highlight or otherwise indicate to the user one or more recommended set of network document changes, 1330, 1335, and 1340. The computing device may recommend one or more sets of network document changes by simulating all possible optimization paths (or some of the possible optimization paths). In some aspects, the changes recommended by the computing device might not have the highest expected traffic potential 1315. Instead, the computing device may recommend the combination of changes that work in concert with each other, according to the “Traveling Salesman Problem” algorithm described below. As a brief example, if a salesman were given a task to travel to five cities, but one of those cities took the salesman in the wrong direction of the rest of the cities, the salesman might skip that city, in order to cover more total cities.

The algorithm for recommending network document changes may be similar to the “Traveling Salesman Problem” algorithm. However, the “cities” in the Traveling Salesman Problem may be represented by the different optimization simulations, and the “distance” in the Traveling Salesman Problem may be represented by the expected traffic potential (ERP). A brief summary of the Traveling Salesman Problem will now be described.

The Travelling Salesman Problem (TSP) may be formulated as an integer linear program. Label the “cities” with the numbers 0, . . . , n and define:

$${x}_{ij} = \{ \begin{matrix}1 & the path goes from city i to city j \\ 0 & otherwise\end{matrix}$$

For i=1, . . . , n, let uᵢ be an artificial variable, and take cᵢⱼ to be the distance from city i to city j. Then the TSP may be written as the following integer linear programming problem:

$$\begin{matrix}min {\sum }_{i = 0}^{n} {\sum }_{j \neq i , j = 0}^{n} {c}_{ij} {x}_{ij} & \\ 0 \leq {x}_{ij} \leq 1 & i , j = 0 , … , n \\ {x}_{ij} ∈ Z & i , j = 0 , … , n \\ {\sum }_{i = 0 , i \neq j}^{n} {x}_{ij} = 1 & j = 0 , … , n \\ {\sum }_{j = 0 , j \neq i}^{n} {x}_{ij} = 1 & i = 0 , … , n \\ {u}_{i} - {u}_{j} + {nx}_{ij} \leq n - 1 & 1 \leq i \neq j \leq n\end{matrix}$$

In the first set of equalities, each city may be arrived at from exactly one other city. In the second set of equalities, from each city there may be a departure to exactly one other city. The last constraints enforce that there is only a single tour covering all cities, and not two or more disjointed tours that only collectively cover all cities. To prove this, it will be described below that (1) every feasible solution contains only one closed sequence of cities, and (2) for every single tour covering all cities, there are values for the dummy variables uᵢ that satisfy the constraints.

To prove that every feasible solution contains only one closed sequence of cities, it suffices to show that every subtour in a feasible solution passes through city 0 (noting that the equalities ensure there can only be one such tour). For if we sum all the inequalities corresponding to xᵢⱼ=1 for any subtour of k steps not passing through city 0, we obtain:

nk≦(n−1)k,

which is a contradiction.

It now must be shown that for every single tour covering all cities, there are values for the dummy variables uᵢ that satisfy the constraints.

Without loss of generality, define the tour as originating (and ending) at city 0. Choose uᵢ=t if city i is visited in step t (i, t=1, 2, . . . , n). Then

uᵢ−uⱼ≦n−1,

since uᵢ can be no greater than n and uⱼ can be no less than 1; hence the constraints are satisfied whenever xᵢⱼ=0. For xᵢⱼ=1, we have:

uᵢ=uⱼ+nxᵢⱼ=(t)−(t+1)+n=n−1,

satisfying the constraint.

Returning to FIG. 13, it may be the combination of selected optimizations that, combined together, represent the best (or one of the best) possible set of optimizations and ranking changes for an analyzed network document or website. For example, the computing device may determine that that the set of changes 1330 recommended for the webpage ending in “/lawyer-website-design-portfol . . . online-video-a-media”, the set of changes 1335 recommended for the webpage ending in “/blog/category/case-studies/se . . . engine-optimization/”, and the set of changes 1340 recommended for the webpage ending in “/lawyer-web-design/index.html” provide the best (or one of the best) possible set of optomizations and ranking changes for a particular website comprising these webpages. The computing device may highlight these recommendations, as illustrated in FIG. 13. Furthermore, the optimizations may factor in the user's preferences or otherwise personalized to the user. For example, if the user prefers to make content-based changes or optimizations and to avoid link-based optimizations, the computing device may weight paths that favor content optimizations to give a unique path of optimizations for the user. A user may select one of the highlighted set of changes, and the computing device may display the recommended set of changes to the user.

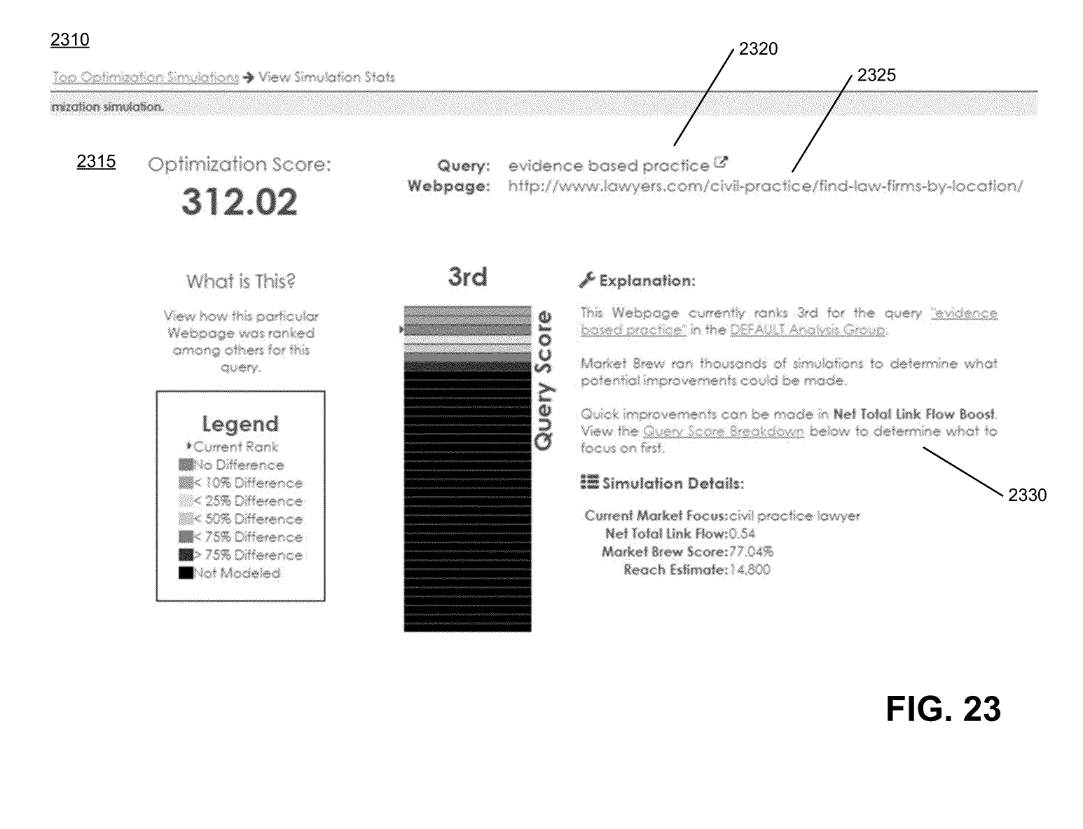

FIG. 23 illustrates an example interface 2310 for displaying simulation statistics for a top optimization simulation according to one or more aspects described herein. The interface 2310 may display a score 2315 for the website or a webpage, which may indicate how the website or webpage was ranked among other websites or webpages for a particular search query 2320. For example, the analyzed webpage 2325 may be ranked third for the query 2320 “evidence based practice” in an analysis group. The interface 2310 may display one or more recommendations 2330 to improve the analyzed website or webpage. The recommendation 2330 (or a portion thereof) may be selectable to display the recommendations to the user.

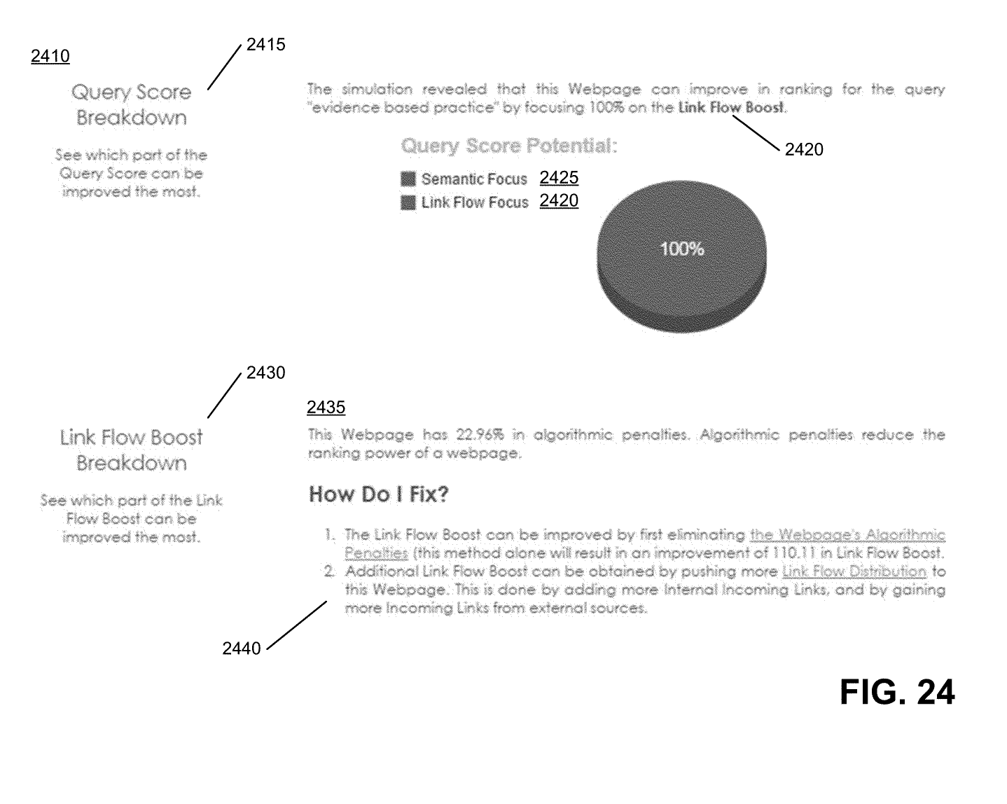

FIG. 24 illustrates an example interface 2410 for displaying recommendations for changes to a network document or website according to one or more aspects described herein. The interface 2410 may display a breakdown 2415 for the webpage's score, including one or more recommendations for improving the score. For example, the exemplary interface 2410 indicates that the query score for the webpage can be improved in ranking for a particular search query by focusing on changes to the LINK FLOW 2420, rather than the semantics 2425 of the webpage. The interface 2410 may also display a breakdown 2430 for the recommended changes (e.g., LINK FLOW boost 2420). The interface 2410 may indicate 2435 one or more problems with the webpage (e.g., the webpage has 22.96% in algorithmic penalties). The interface 2440 may also indicate 2440 how to fix the one or more problems. For example, the user may improve the webpage's ranking by eliminating algorithmic penalties and/or pushing more LINK FLOW distribution to the webpage (e.g., by adding more internal incoming links, and by gaining more incoming links from external sources). Based on the recommendations provided by the computing device, the user may make one or more of the recommendation changes and perform a re-crawl to determine how the modifications affected the rank, scores, etc. of the webpage.

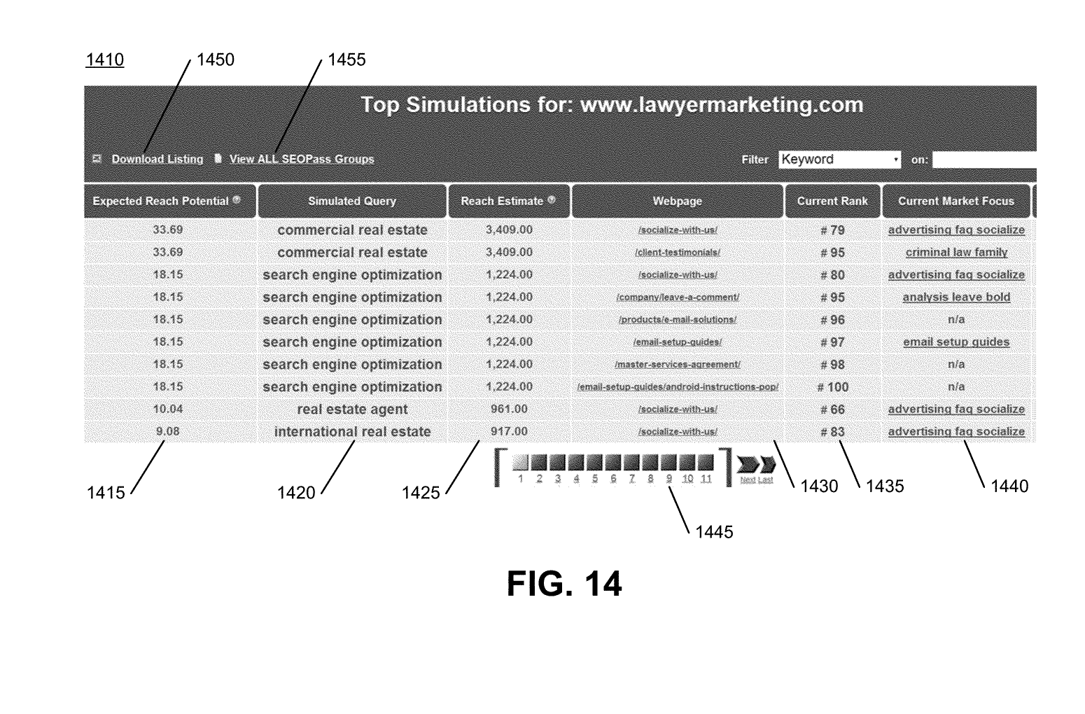

FIG. 14 illustrates an additional example interface 1410 for displaying expected traffic (e.g., REACH) potentials 1415 (e.g., ERP) according to one or more aspects described herein. In particular, the top simulations for webpages 1430 in a particular website (e.g., “www.lawyermarketing.com”) may be displayed to the user. The expected traffic potential 1415 for each simulated query 1420 and webpage 1430 combination may be displayed. Other information, such as the traffic (REACH) estimate 1425, the URL of the webpage 1430, the current rank 1435 of the webpage for the simulated query, and the market focus 1440 of the webpage may also be displayed. The traffic estimate 1425 may be determined in a number of ways. For example, the traffic estimate 1425 may be determined based on the search traffic volume for one or more keywords. As previously explained, the search traffic volume may be obtained directly from whichever search engine that the computing device is estimating it for. The traffic estimate 1425 may additionally or alternatively be based on the revenue for one or more keywords. A user may upload his or her own personalized traffic estimate that is based off of revenue and not, for example, traffic. The traffic estimate 1425 may additionally or alternatively be based on the conversions for one or more keywords. A user may upload his or her own personalized traffic estimate that is based off of conversion percentage and not, for example, traffic.

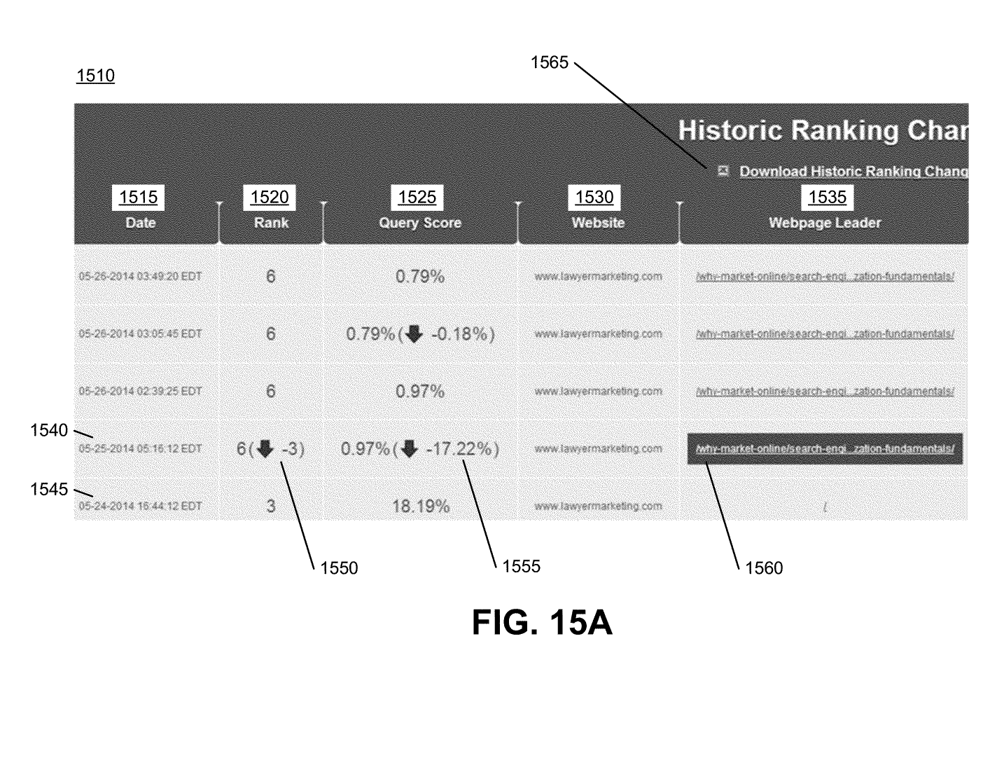

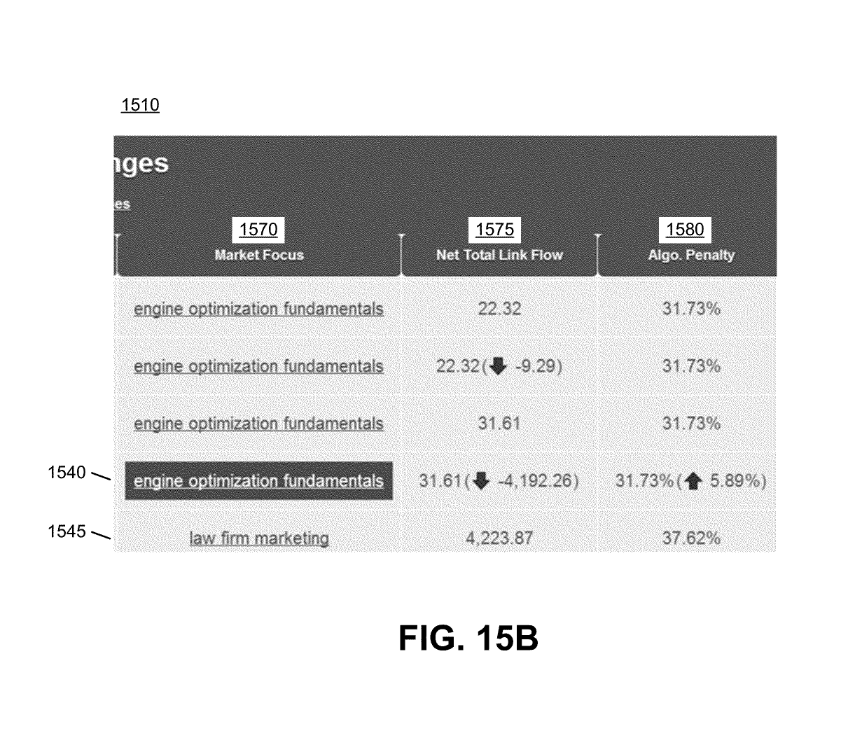

FIGS. 15A-B illustrate an example interface 1510 for displaying historic search result ranking changes according to one or more aspects described herein. Reference is first turned to FIG. 15A. The results may be sorted by date 1515 (e.g., most recent first or most recent last). For each date 1515, the computing device may store and/or display the rank 1520 of the network document (e.g., webpage) or website, and/or the query score 1525 of the network document. For example, on 05-25-2014 05:16:12 EDT (the search result listing 1540) may have a rank of 6 and a query score of 0.97%. As another example, on 05-24-2014 16:44:12 EDT (the search result listing 1545) may have a rank of 3 and a query score of 18.19%. If there was a change (e.g., an increase or decrease) in rank 1520 and/or score 1525, the computing device may identify or otherwise highlight the change. For example, the ranking change from the listing 1545 (ranking: 3) to the listing 1540 (ranking 6) may be identified 1550 (e.g., highlighted) as a drop in ranking by 3 spots. Similarly, the query score change from the listing 1545 (score: 18.19%) to the listing 1540 (score: 0.97%) may be identified 1555 (e.g., highlighted) as a drop in score 1555 by 17.22%.

The interface 1510 may also list the webpage leader 1535 of the website 1530 for each date 1515. The webpage leader 1535 may comprise the webpage from the website 1530 having the highest expected traffic (REACH) potential and/or the highest traffic (REACH) estimate of the website's webpages. For example, the webpage leader for the listing 1545 may comprise the base page (e.g., homepage) for the website (www.lawyermarketing.com/). The webpage leader for the listing 1540 may have changed to the webpage ending in “/why-market-online/search-engi . . . zation-fundamentals/.” In some aspects, the interface 1510 may highlight 1560 the webpage leader 1535 if the webpage leader changed from one date to the next. The interface 1510 may also display an option 1565 for the user to download a listing of the historical ranking changes, such as in a spreadsheet or other format.

With reference to FIG. 15B, the interface 1510, which is a continuation of the interface 1510 illustrated in FIG. 15A, may display the MARKET FOCUS 1570 for each date. For example, the market focus for listing 1540 may comprise “engine optimization fundamentals,” and the market focus for listing 1545 may comprise “law firm marketing.” The interface 1510 may display the NET TOTAL LINK FLOW 1575 (and any changes to the NET TOTAL LINK FLOW 1575) and/or the search engine score 1580 (e.g., Algo. Penalty or SEO ENGINE (now Market Brew™) Score), including any changes to the search engine score 1580.

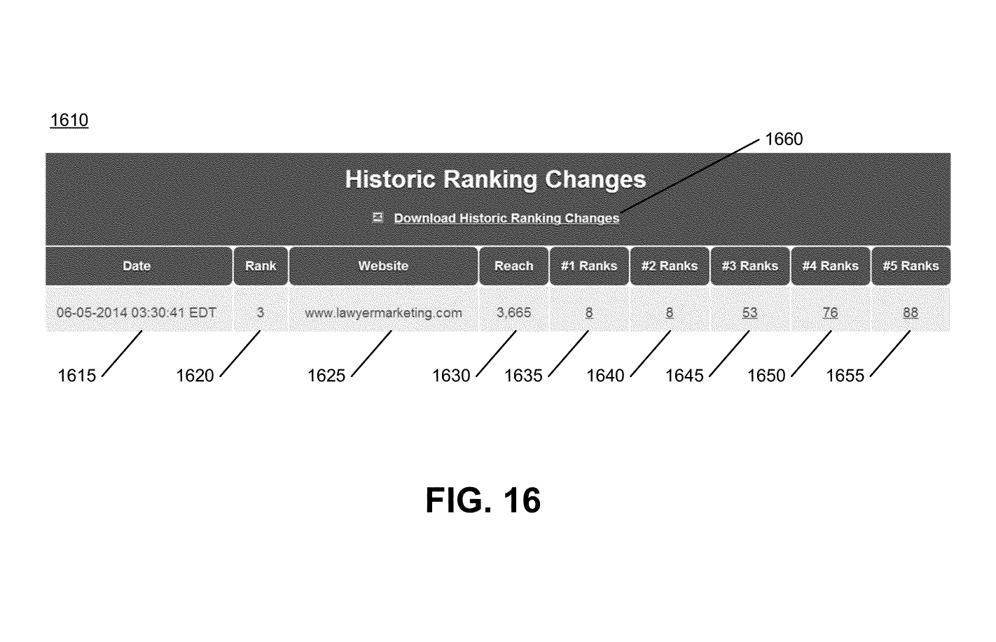

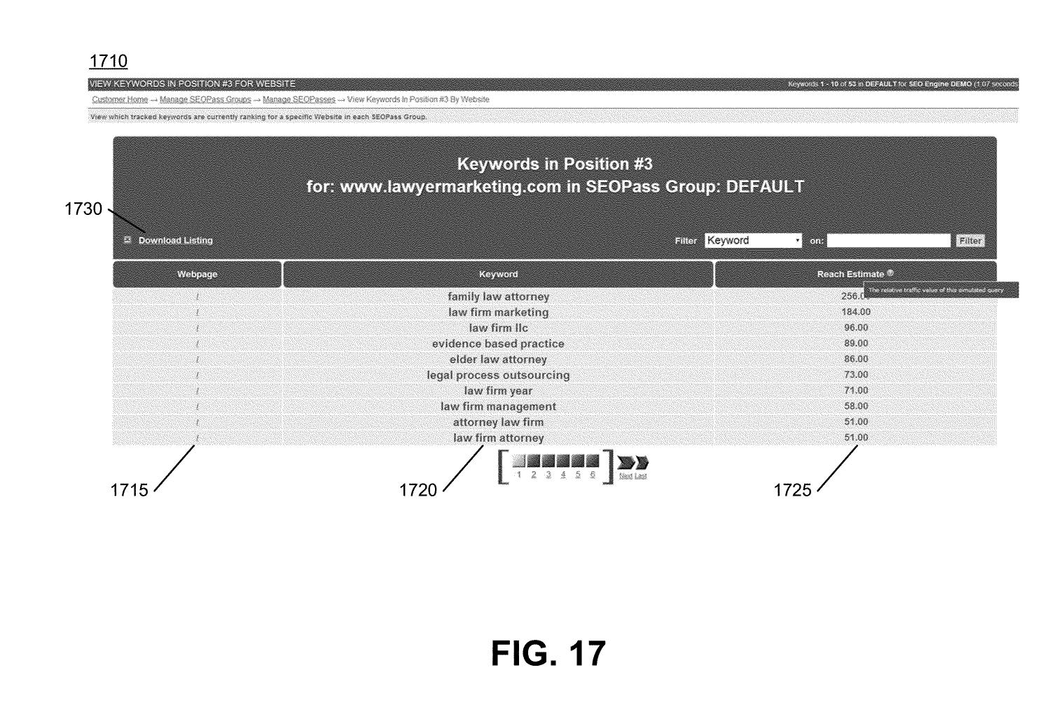

FIG. 16 illustrates another example interface 1610 for displaying historic search result ranking changes according to one or more aspects described herein. In particular, each traffic figure for a website can be further drilled into, and additional details for the website may be displayed. For example, for the date 06-05-2014 03:30:41 EDT (1615), the rank 1620 and/or traffic 1630 (REACH), such as the expected traffic potential or the traffic estimate described above, may be displayed for a particular website 1625 (e.g., “www.lawyermarketing.com”) on a particular date 1615. Furthermore, the number of times that the website was ranked number 1, ranked number 2, etc. (as measured over a predetermined period of time) may also be displayed to the user. For example, the website 1625 (e.g., “www.lawyermarketing.com”) may have had 8 number 1 ranks 1635, 8 number 2 ranks 1640, 53 number 3 ranks 1645, 76 number 4 ranks 1650, 88 number 5 ranks 1655, and so on. Each of the ranks may be selectable, and when selected, may display search queries (e.g., keywords) for which the website (e.g., “www.lawyermarketing.com”) is currently ranked for the selected rank, as will be described in further detail with reference to FIG. 17. The interface 1610 may also display an option 1660 for the user to download a listing of the historical ranking changes, such as in a spreadsheet or other format.

FIG. 17 illustrates an example interface 1710 for displaying keywords at a particular ranking position according to one or more aspects described herein. In particular, the user can also drill into each ranking. In the example illustrated in FIG. 17, the user may want to see the search queries 1720 (e.g., keywords) for which the website is currently ranking #3. Each search query may comprise a search query generated and/or simulated by the computing device. With brief reference to FIG. 16, the user may select the hyperlink 1645 for “#3 Ranks,” and the computing device may cause the interface 1710 illustrated in FIG. 17 to be displayed responsive to the user selecting the hyperlink 1645.

The interface 1710 may display the network document 1715, such as a webpage (e.g., “www.lawyermarketing.com/”). The interface 1710 may also display the search queries 1720 for which the network document 1715 ranks number 3. For example, the webpage “www.lawyermarketing.com/” may rank number 3 for the search query “family law attorney,” “law firm marketing,” “law firm 11c,” “evidence based practice,” and the like. The interface 1710 may display the traffic (e.g., REACH) estimate value 1725 for each search query 1720 for the network document 1715. For example, the webpage “www.lawyermarketing.com/” may have a traffic estimate value of 256.00 for the query “family law attorney.” As another example, the webpage may have a traffic estimate value of 184.00 for the query “law firm marketing.” The interface 1710 may also display an option 1730 for the user to download a listing of the historical ranking changes, such as in a spreadsheet or other format.

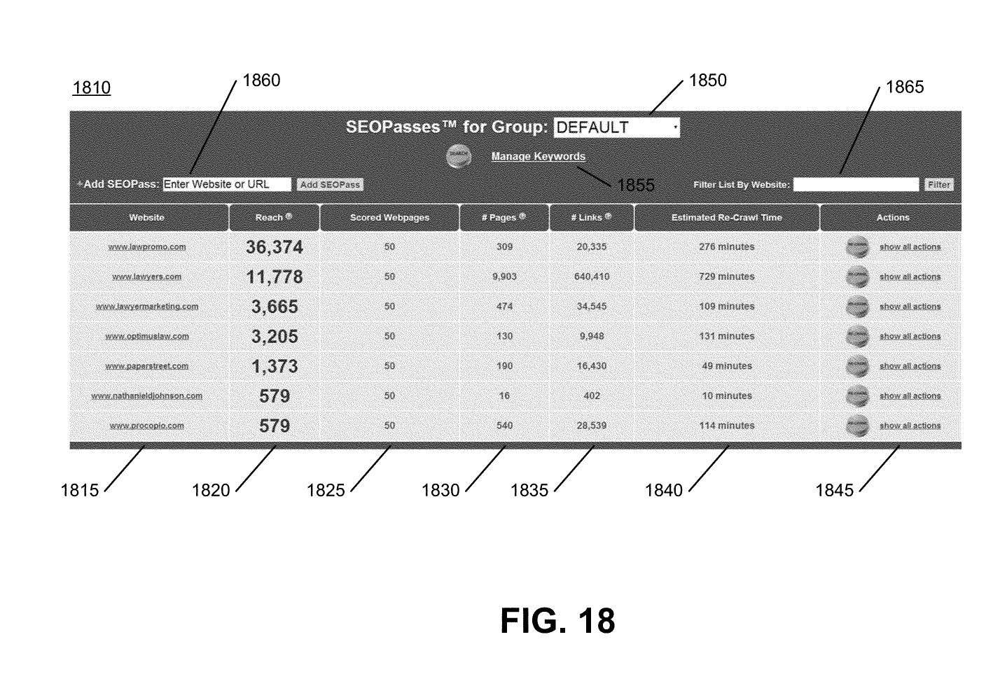

FIG. 18 illustrates an example interface 1810 for displaying a group of websites according to one or more aspects described herein. A grouping of websites 1815 (e.g., www.lawpromo.com, www.lawyers.com, etc.) may be defined by a virtual world that the simulator described herein works on. For example, the websites 1815 illustrated in FIG. 18 may be part of the DEFAULT group 1850. The interface 1810 may provide a pulldown menu or other graphical user interface (GUI) element that allows the user to select between various groups, including the DEFAULT group 1850. The interface 1810 may also display a field 1860 for the user to add a website or URL to the group 1850. By grouping websites, the interface 1810 generated by a computing device may display to the user websites having the same or similar subject matter. Accordingly, a user may be able to compare various characteristics of a website to other similar websites.

The interface 1810 may display various characteristics of the websites in the virtual world, including the traffic (e.g., REACH) value 1820, the number of scored webpages 1825 in the website, the total number of pages 1830 in the website, the number of links 1835 in the website, and the estimated re-crawl time 1840 of the website. As explained above, the traffic (e.g., REACH) value 1820 may comprise the expected traffic potential and/or the traffic estimate for the website. Selectable options 1845 for the user to take action on the website may also be displayed. For example, the user may select to re-crawl the URL. Other actions may include edit/delete, removing the website from the analysis group, managing scheduled crawls, managing search engine rules, and/or generating custom reports on the analysis.

The interface 1810 may display a field 1865 for filtering websites (e.g., including and/or excluding certain websites) from the list of websites 1815. The interface 1810 may also display an option 1855 for a user to manage search queries (e.g., keywords) for the website. In response to a selection of the option 1855, the computing device may display an interface for a user to add, remove, or otherwise manage keywords for the analysis group.

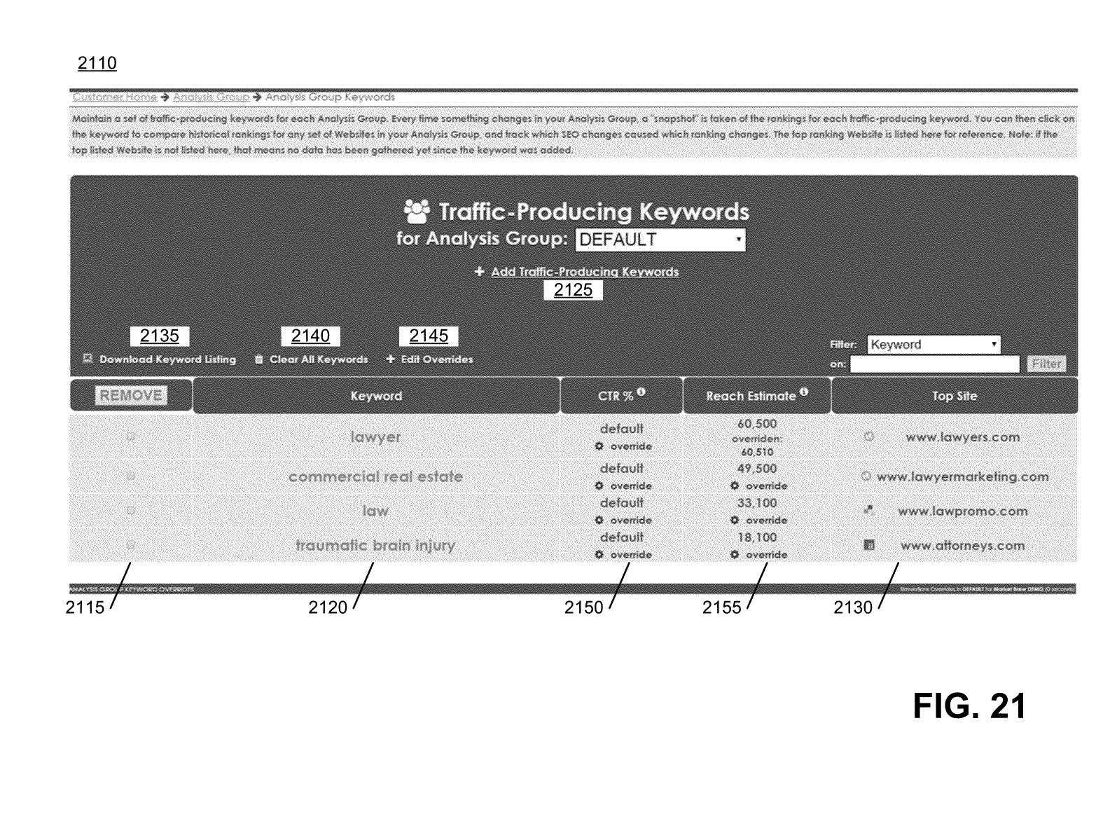

FIG. 21 illustrates an example interface 2110 for a user to manage search queries according to one or more aspects described herein. The interface 2110 may be displayed in response to a selection of the option 1855 illustrated in FIG. 18. The interface 2110 may be used by a user to maintain a set of keywords, such as traffic-producing keywords, for each analysis group. Each time something changes in the analysis group, a snapshot of the rankings for each keyword may be taken. The user may click on a keyword to compare its historical rankings for any set of websites in the analysis group and to track which search engine changes caused which ranking changes. The interface 2110 may display the top ranking website 2130 for reference. If the top listed website is not displayed, data for the website might not have been gathered since the keyword was added.

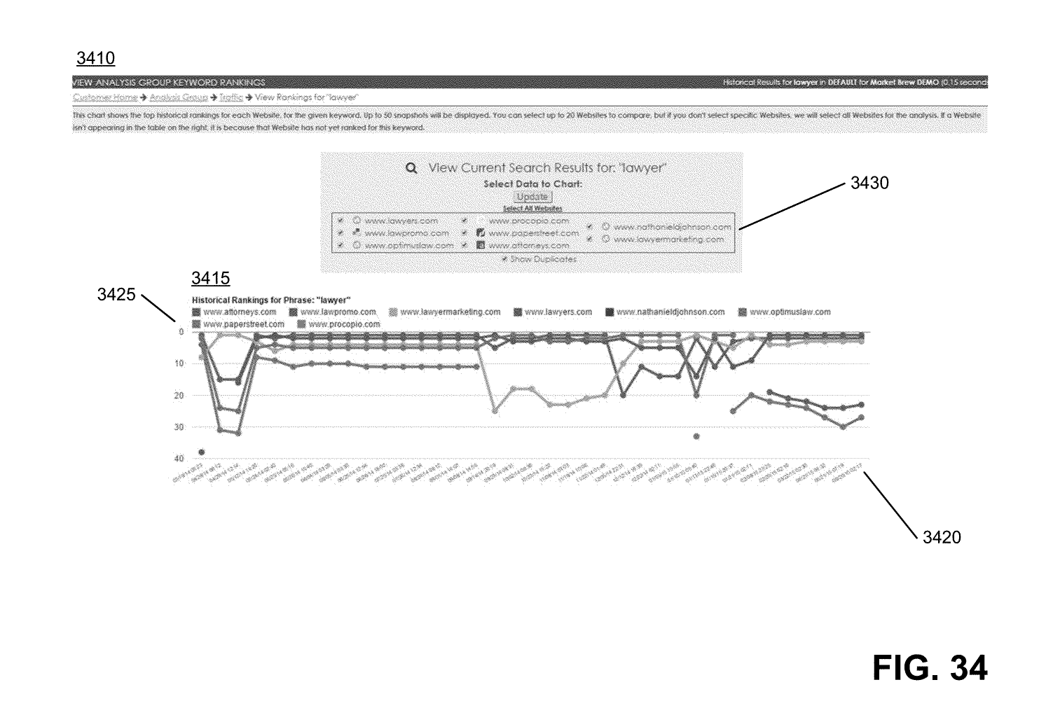

FIG. 34 illustrates an example interface 3410 for displaying historical and/or current search rankings according to one or more aspects described herein. The interface 3410 may be displayed in response to a selection of one of the keywords illustrated in FIG. 21, such as the keyword “lawyer.” The interface 3410 may comprise a graphical display 3415 of the historical rankings of websites for the keyword “lawyer.” The graphical display 3415 may list dates and times 3420 and corresponding website rankings 3425 for each date. The interface 3410 may also comprise selectable options 3430 for the user to select the one or more websites to be displayed on the graphical display 3415. As an alternative to interface 3410, the interface 1510 illustrated in FIGS. 15A and 15B may be displayed in response to a selection of one of the keywords illustrated in FIG. 21.

Returning to FIG. 21, the interface 2110 may display an option 2115 for the user to remove a keyword 2120 from the analysis group. The interface 2110 may also display an option 2125 for the user to add a keyword to the analysis group. The interface 2110 may also comprise an option 2135 for the user to download a keyword listing, such as in a spreadsheet or other format. The interface 2110 may also display an option 2140 to clear all keywords in the analysis group and/or an option 2145 for the user to edit overrides. The user may input his or her own value (e.g., for a CTR percentage and/or a traffic estimate) and override the default simulation for the keyword. The interface 2110 may display a listing 2150 of CTR percentages for each keyword and a listing 2155 of the traffic estimate for each keyword. Each CTR percentage and/or traffic estimate may be overridden by the user. For example, the traffic estimate for the keyword “lawyer” may be overridden by the user from a value of 60,500 to a value of 60,510. The user may select any of the override options for individual CTR percentages 2150 or traffic estimates 2155 or may select the keyword 2120 or the edit overrides option 2145 to manage overrides.

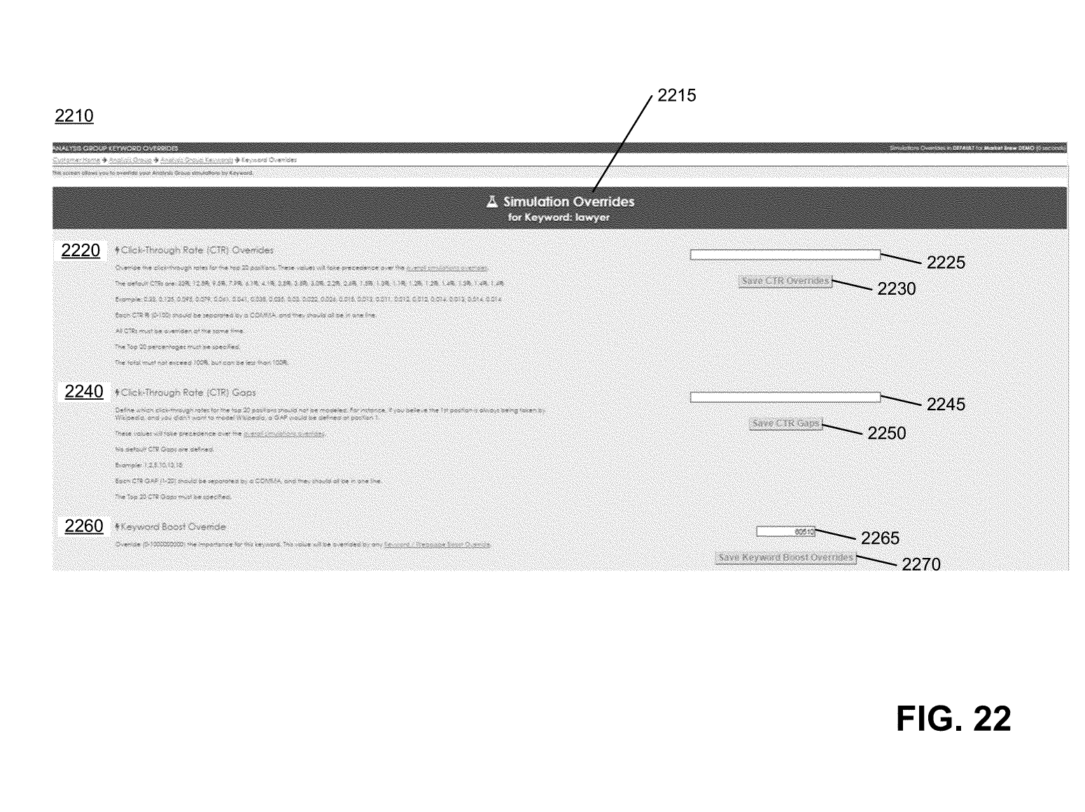

FIG. 22 illustrates an example interface 2210 for a user to manage overrides according to one or more aspects described herein. The interface 2210 may be displayed in response to a selection of an option displayed on the interface 2110 illustrated in FIG. 21 to override a CTR and/or traffic estimate. The interface 2210 may display simulation overrides 2215 for a particular keyword, such as the keyword “lawyer.” A user may provide CTR overrides 2220. For example, the user may override the default CTR for a plurality of the top X positions, such as the top 20 positions. Exemplary default CTRs for the top 20 positions may be 33%, 12.5%, 9.5%, 7.9%, 6.1%, 4.1%, 3.8%, 3.5%, 3.0%, 2.2%, 2.6%, 1.5%, 1.3%, 1.1%, 1.2%, 1.2%, 1.4%, 1.3%, 1.4%, 1.4%. The default CTRs for the top X positions may add up to 100%, but can also add up to a value less than 100%. The CTR overrides 2220 may also provide the user with one or more instructions for adjusting the default CTR values. In some aspects, the user may override all of the CTRs (e.g., for the top 20 positions) at the same time. The CTR overrides 2220 may provide a field 2225 for the user to input CTR values, and/or an option 2230 for the user to save the CTR values inputted by the user.

The interface 2210 may also provide CTR gaps overrides 2240. The user may identify which CTRs for the top X (e.g., 20) positions should not be modeled. For example, if the user believes that one of the positions (e.g., the first position) is being taken (e.g., consistently or always) by a particular website (e.g., WIKIPEDIA), and the user does not want to model that website, the user may identify a gap for the first position. The CTR gaps 2240 may provide a field 2245 for the user to input CTR gaps, and/or an option 2250 for the user to save the CTR gaps inputted by the user. For example, the user might provide the following input: 1, 2, 5, 10, 13, 18. The computing device might place a gap at each of those positions, and the website at each gap position might not be modeled. The CTR gaps 2240 may also provide the user with one or more instructions for adding CTR gaps.

The interface 2210 may also provide keyword boost overrides 2260. The user may input a value for the importance of the keyword. The keyword boost overrides 2260 may provide a field 2265 for the user to input the new value for the importance of the keyword, such as a value of 60510. The keyword boost overrides 2260 may also provide an option 2270 for the user to save the importance value inputted by the user.

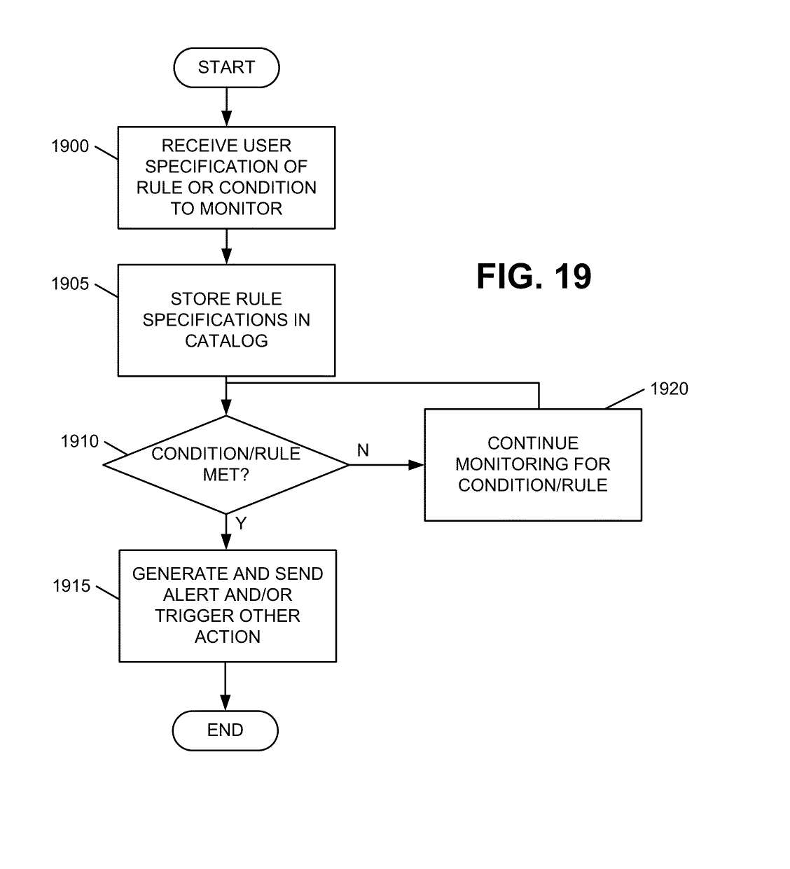

FIG. 19 illustrates an example method for creating and receiving alerts through an optimization engine or tool. In step 1900, the optimization engine may receive a user specification of a rule or condition that they wish to monitor for in the website, webpage, or link. The rule or condition may include a number of broken links, a LINK FLOW score, amount of duplicate content and the like. The rule or condition may also be changes in the ranking of a particular network document, changes in the ranking of competitors' network documents, changes in the expected traffic potential, and/or changes in the traffic estimated, as described herein. In step 1905, the optimization engine may store the rule specifications in a catalog configured to store rules that are applied by the optimization engine. In step 1915, the optimization engine may determine the rule or condition has been met or satisfied. If so, the optimization engine may generate and send an alert to the user in step 1920. If not, the engine may continue monitoring for the condition or rule in step 1925. The rule may, additionally or alternatively, trigger an external action such as a process outside of the search engine or re-crawling. In one example, the search engine may send an alert along with suggestions for eliminating or improving the condition met.

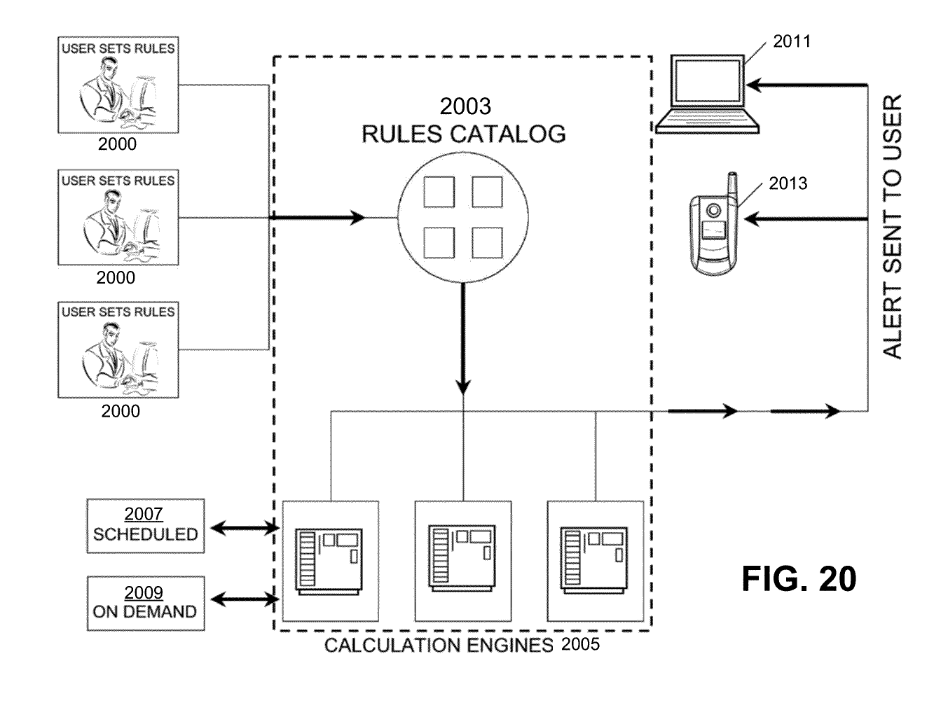

FIG. 20 illustrates a block diagram of an alert system. Inputted alerts 2000 may be sent to catalog 2003, which maintains rules that are applied by the calculation engines 2005. The calculation engines 2005 may be configured to organize and analyze data either by schedule 2007 or by on-demand requests 2009. During the course of organizing and/or analyzing data, an alert triggered may be triggered by one or more of alerts 2000. When such an event occurs, the calculation engines 2005 may send an alert to client devices 2011 and/or 2013. Alerts catalog 2003 and calculation engines 2005 may be part of a single system or may be separate from one another. For example, alerts catalog 2003 and calculation engines 2005 may be part of a distributed optimization engine.

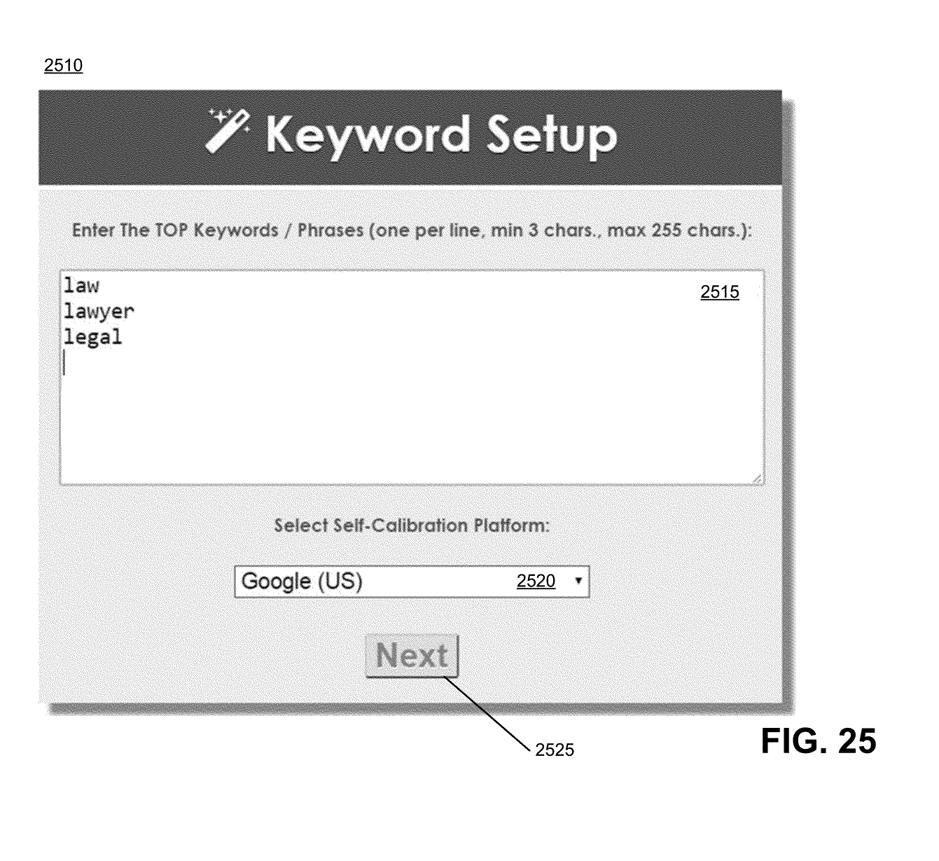

FIG. 25 illustrates an example interface 2510 for displaying keyword setup according to one or more aspects described herein. The interface 2510 may allow a user to choose to create a self-calibrated analysis group. For example, the interface 2510 may display an input field 2515 that allows the user to input keywords for analysis, as previously described. The interface 2510 may also allow the user to select a search engine environment to target 2520, and the selected search engine environment may comprise any search engine, including GOOGLE (US), GOOGLE (UK), or any other search engine. In response to a selection of the next button 2525, the computing device may perform the analyses described herein based on the keywords provided by the user and the target search engine environment selected by the user.

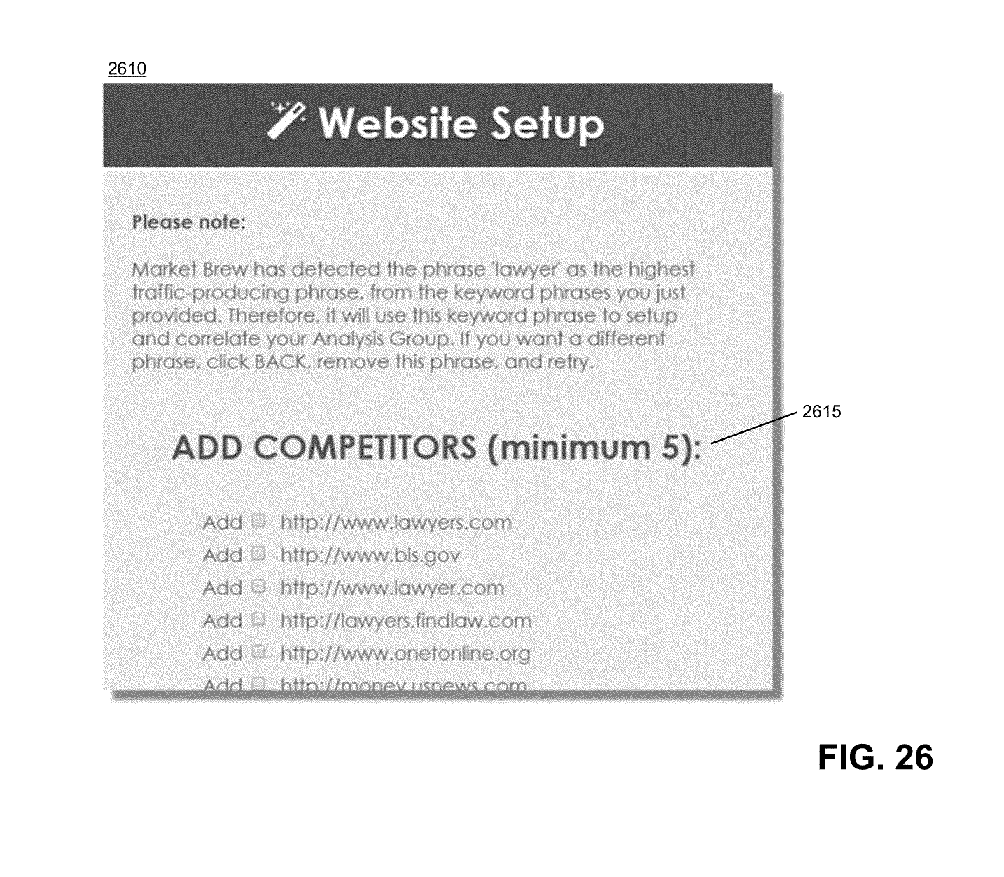

FIG. 26 illustrates an example interface 2610 for displaying website setup according to one or more aspects described herein. In some aspects, the interface 2610 may be displayed in response to a selection of the next button 2525 illustrated in FIG. 25. The computing device may determine which of the keywords comprises the highest traffic-producing phrase. The computing device may use this keyword to generate an analysis group or other grouping of websites. The computing device may determine one or more competitor websites that are currently ranking on the top X (e.g., top 20) results for the keywords on the user's target search engine. As previously explained, website rankings may be based on each website's score, such as a query score. The current ranking for the specified search query on the target search engine may be pulled. For example, if the user selected “lawyer” and Google US as the search engine, the system may ping a third party computing device to determine the current search results, and those websites may be added to the list of websites for the top 20 search results. The interface 2610 may list the competitor websites 2615, and provide the user an option to add one or more of the competitor websites 2615 for the analysis previously described. The optimization engine may compile the data received via the interfaces 2500 and 2600 and self-calibrate its search engine model using a combination of artificial intelligence (e.g., Particle Swarm Optimization) and the standard Pearson Correlation algorithm. A high degree of correlation between the user's search engine model and the user's target search engine environment may result.

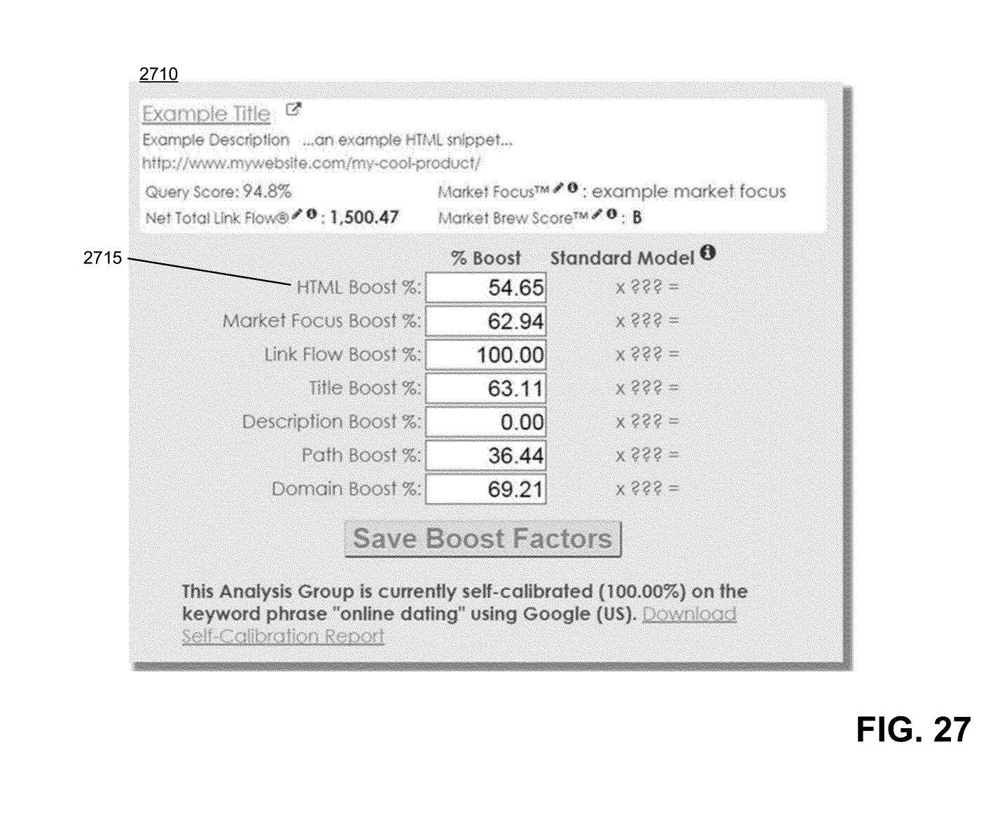

FIG. 27 illustrates an example interface 2710 for displaying boost factors according to one or more aspects described herein. Exemplary boost factors 2715 include, but are not limited to, the HTML boost %, the MARKET FOCUS boost %, the LINK FLOW boost %, the title boost %, the description boost %, the path boost %, and the domain boost %. The values may be used by the computing device to weight one or more of the boost factors 2715 in the analysis described herein. In some aspects, the interface 2710 may allow the user to adjust one or more of the boost factor values. The user may also download a self-calibration report showing the results of the calibration for that keyword in more detail.

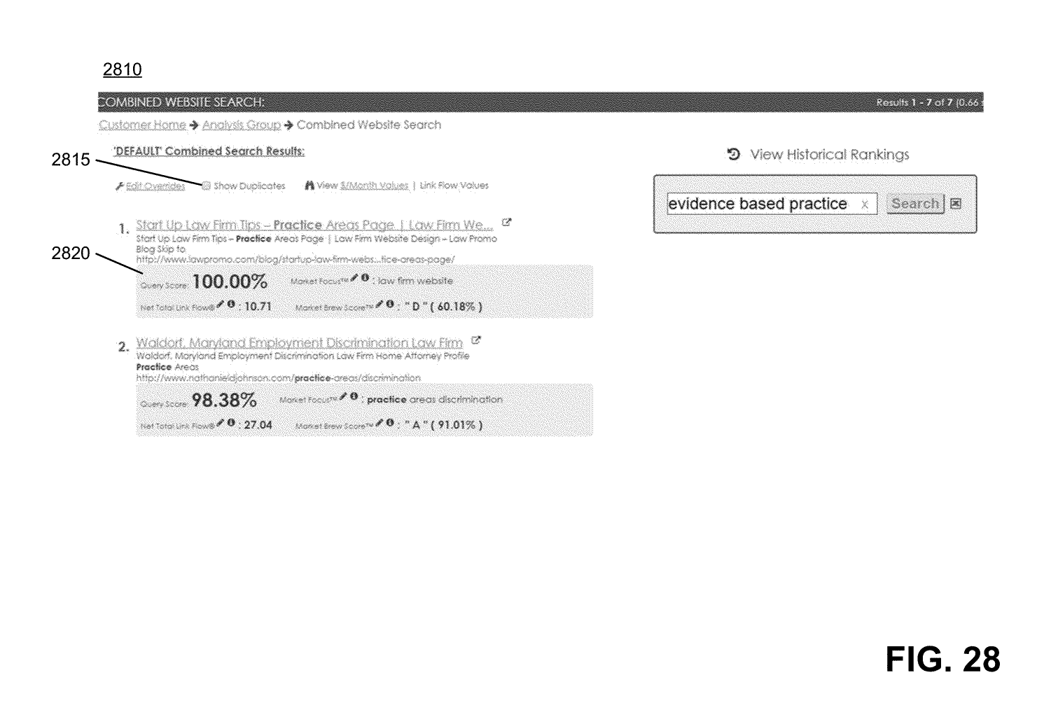

FIG. 28 illustrates an example interface 2810 for displaying a combined website search according to one or more aspects described herein. For example, the interface 2810 may display search results, similar to the interface 710 illustrated in FIG. 7. The interface 2810, however, provides an additional option 2815 (e.g., show duplicates) to show a simulated search results listing for all pages within a selected group of websites. For example, a single website may have multiple webpages within that website appear on the search results listing for the search query selected by the user. The interface 2810 may display more than one webpage from a website in response to a selection of the show duplicates option 2815. The user might choose not to show duplicates by default and show a search results listing that ranks a maximum of one page from each website in the group. For example, the user may de-select the show duplicates option 2815.

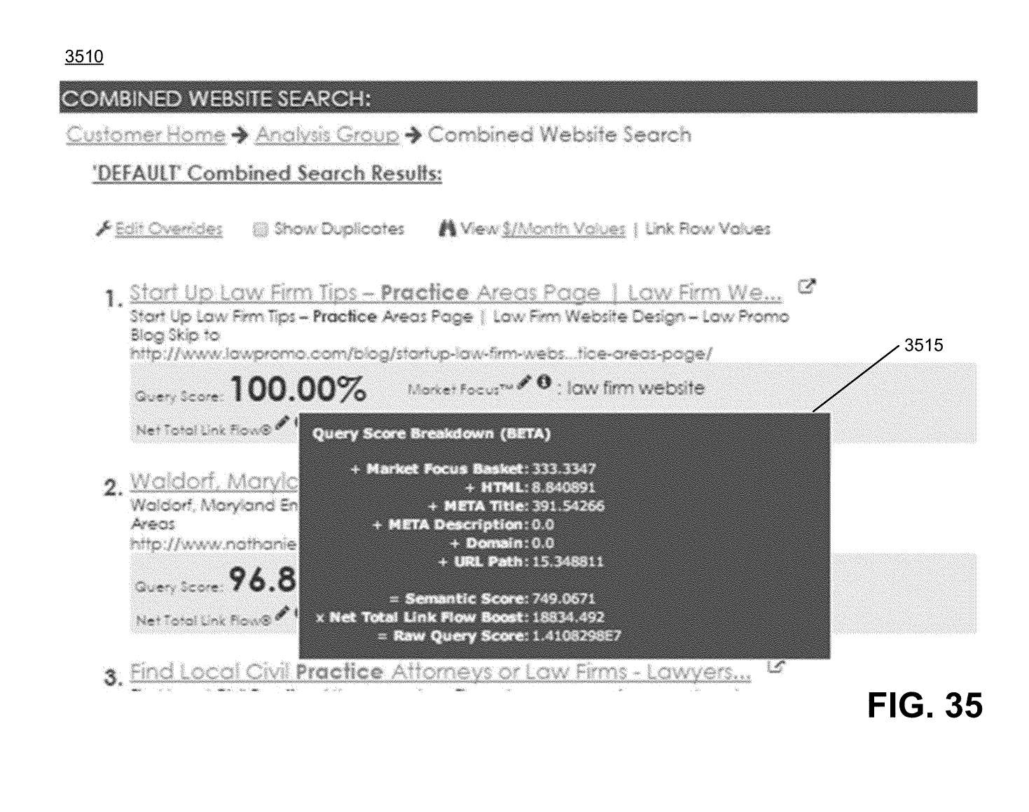

As previously explained, the interface 2810 may also display a query score 2820 for each search result. In some aspects, the user may select or hover over the query score 2820 to see how the corresponding website was scored. FIG. 35 illustrates an example interface 3510 for displaying scoring details according to one or more aspects described herein. The interface 3510 may display a query score breakdown 3515 in response to the user selecting or hovering over the query score.

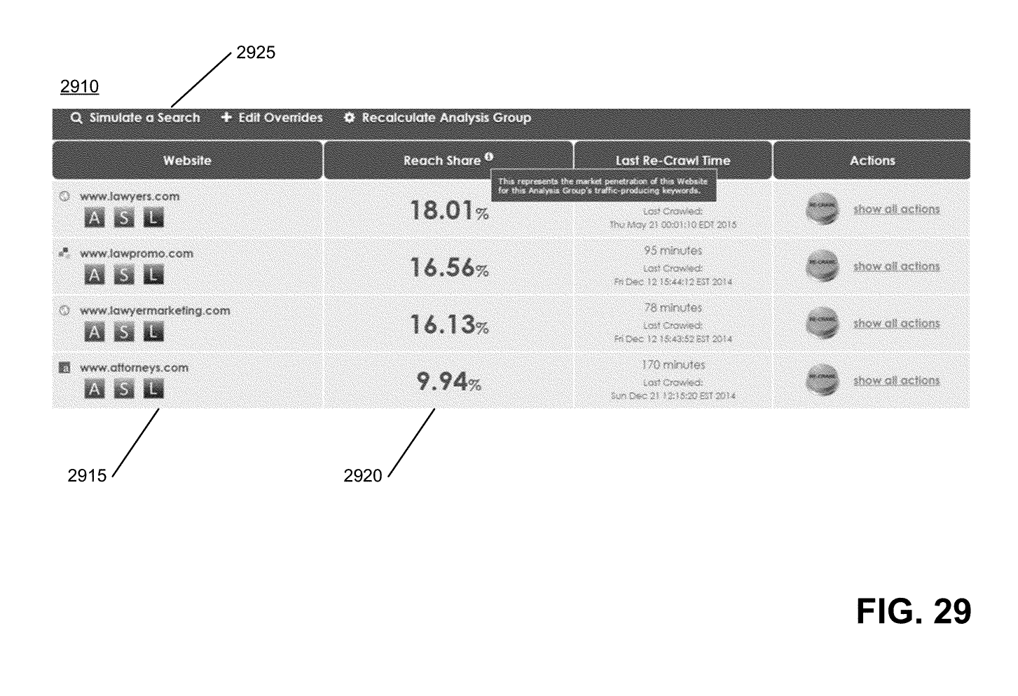

FIG. 29 illustrates an example interface 2910 for displaying website traffic share according to one or more aspects described herein. For example, the interface 2910 may display the websites 2915 in a particular analysis group (or group of websites that the user wishes to examine). The interface 2910 may display a traffic share 2920 (e.g., a REACH share) that indicates the market penetration for each website in the analysis group. The traffic share 2920 may comprise the share of the reach estimate between the websites in the analysis group. In other words, the traffic share 2920 may comprise the percentage share of traffic (e.g., search volume) or a different metric defined by a user override, that a website has relative to the other websites in the analysis group. The traffic estimate may be determined by a computing device, as previously described. The interface 2910 may also comprise a simulate a search option 2925. In response to a selection of the option 2925, a search may be simulated amongst the websites 2915. The interface 2910 may also provide options for the user to edit overrides and/or to recalculate the analysis group, as previously explained.

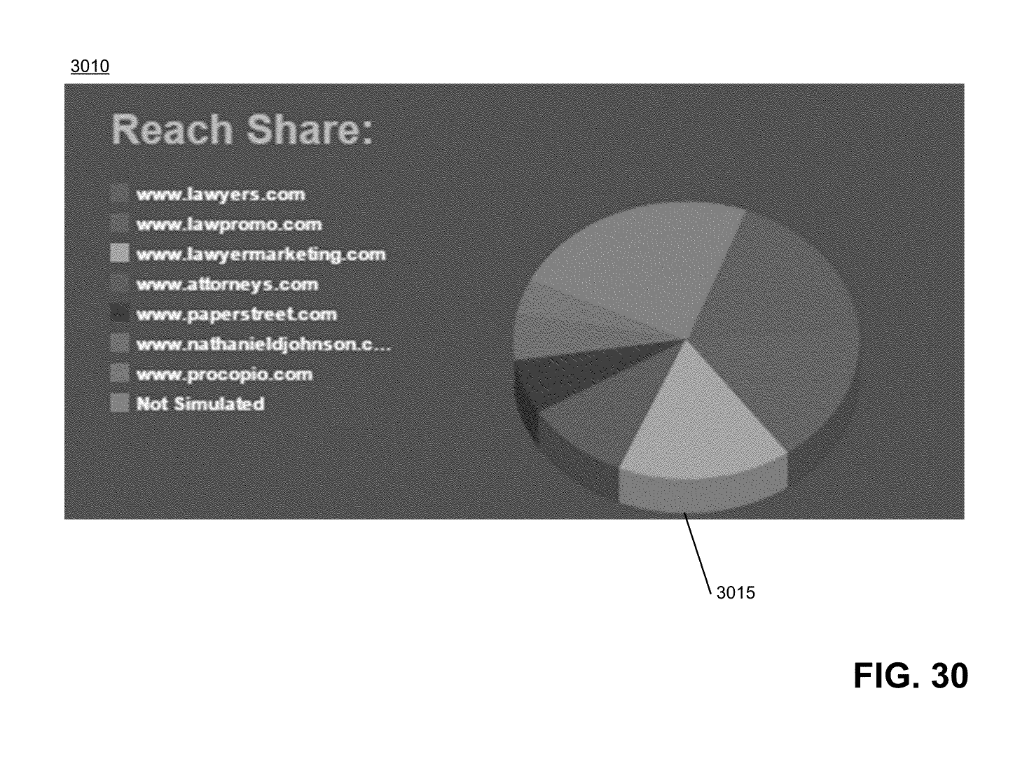

FIG. 30 illustrates another example interface 3010 for displaying website traffic share according to one or more aspects described herein. For example, the interface 3010 may display the traffic share for the websites 2915 listed on the interface 2910. The interface 3010 may display a graphical representation 3015 of the traffic share, such as a pie chart or any other graphical representation of traffic share. The interface 3010 may also display the portion of the traffic share coming from websites that have not been modeled or simulated (e.g., “Not Simulated”). These websites might not have been added to the analysis group.

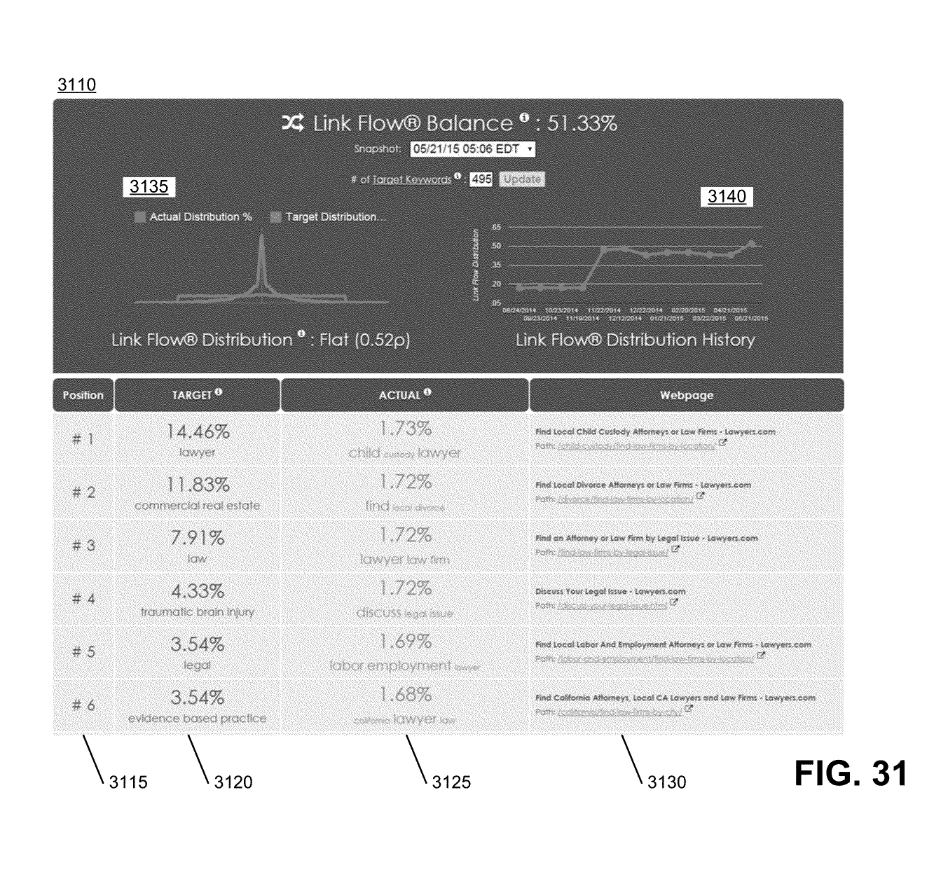

FIG. 31 illustrates an example interface 3110 for displaying link flow distribution according to one or more aspects described herein. In particular, the interface 3110 may display the LINK FLOW distribution for the webpages 3130 within a user-selected website (e.g., sub-domain). The interface 3110 may display 3135 an actual distribution, a target distribution, and/or a market focus. The interface 3110 may also display a LINK FLOW distribution history 3140 for the website. For each webpage 3130, the interface 3110 may display the position 3115, the target distribution 3120, the actual distribution 3125, and/or the market focus.

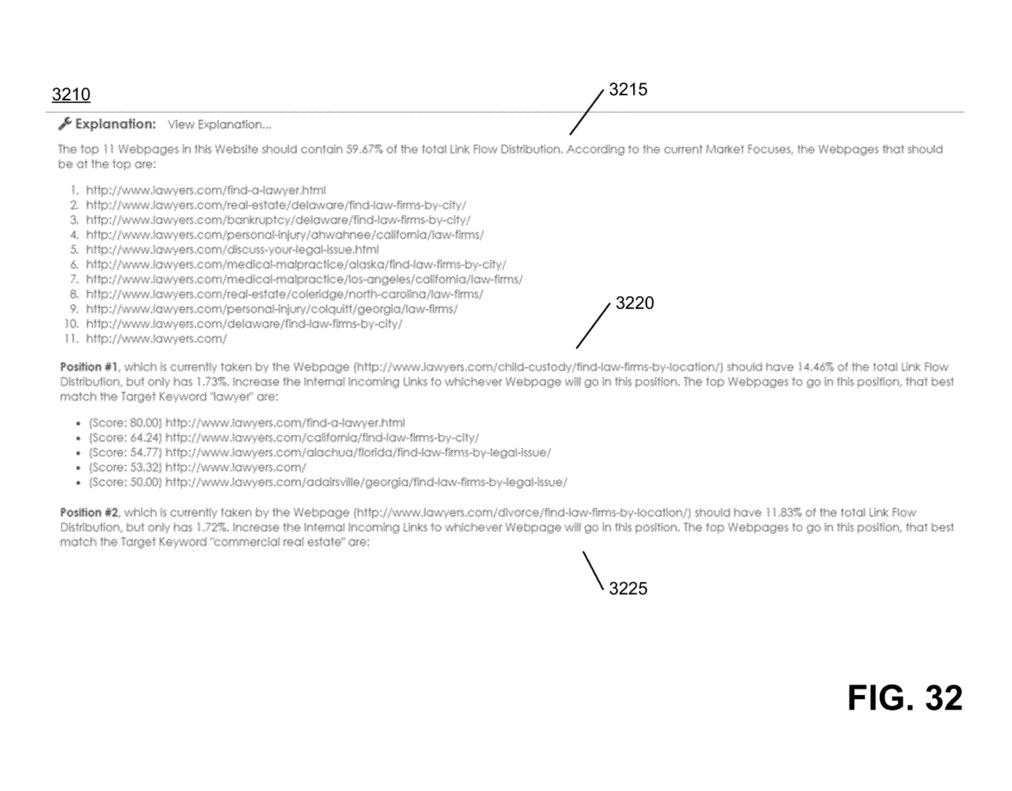

FIG. 32 illustrates an example interface 3210 for displaying webpage recommendations according to one or more aspects described herein. The interface 3210 may provide an explanation 3215 that indicates the webpages in a website that should be at the top of the website in terms of link flow distribution. The interface 3210 may also identify the webpages that are actually at each of the top positions, such as the webpage that is at the first position 3220, the webpage that is at the second position 3225, and so on. For each webpage, the interface 3210 may provide recommendations for increasing or decreasing the LINK FLOW distribution for each of the webpages.

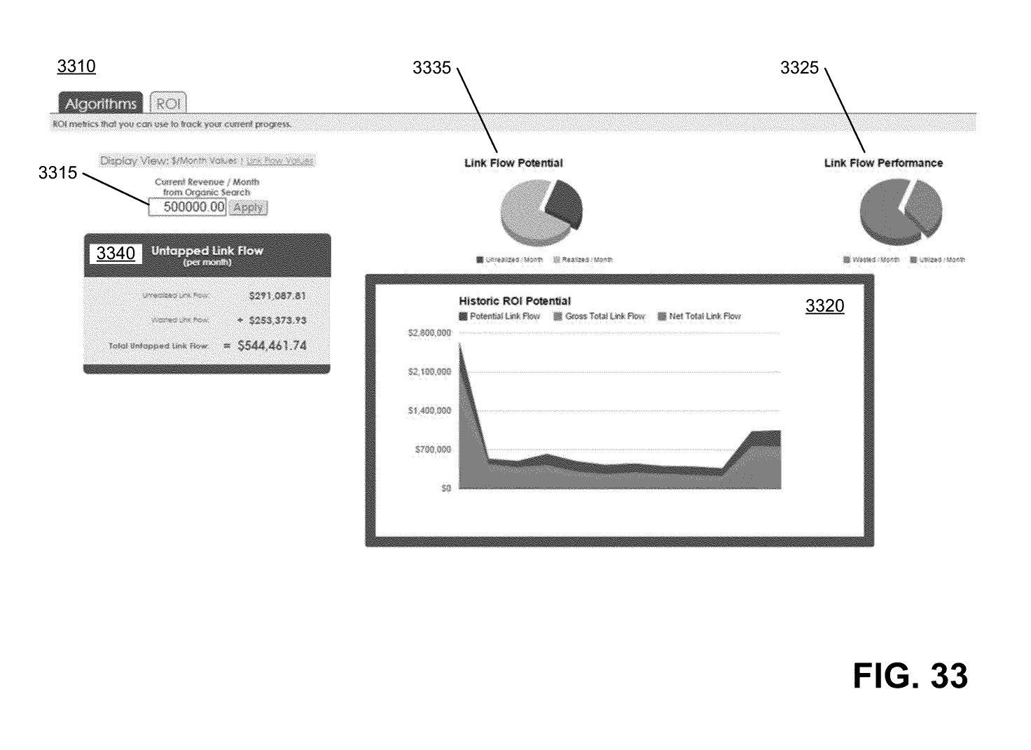

FIG. 33 illustrates an example interface 3310 for displaying an estimate of return on investment (ROI) for a website according to one or more aspects described herein. The interface 3310 may provide an input field 3315 for the user to input a current revenue value (e.g., a current monthly revenue) from searches. The computing device may calculate a dollar-per-link-flow value from the current monthly revenue. This value may be used to show the user how much estimated incremental revenue could be added each month by eliminating penalties and keeping more ranking power within the website. For example, the interface 3310 may display the untapped LINK FLOW 3340, which may comprise the unrealized LINK FLOW plus the wasted LINK FLOW. The interface 3310 may display a historic ROI potential 3320, including the ROI for the gross total LINK FLOW and the net total LINK FLOW. The historic ROI potential 3320 may also display the potential LINK FLOW based on one or more optimizations. The interface 3310 may display a current LINK FLOW performance 3325 (e.g., utilized/month vs. wasted/month) and/or a LINK FLOW potential (e.g., realized/month vs. unrealized/month).

As described in detail above, a navigable, transparent search engine which can be utilized to inspect how a search engine works may be used to optimize websites and other network documents. Such an optimization engine or tool may reside alongside a traditional search engine, and represent the navigation and transparency of that search engine.

It should be understood that any of the method steps, procedures or functions described herein may be implemented using one or more processors in combination with executable instructions that cause the processors and other components to perform the method steps, procedures or functions. As used herein, the terms “processor” and “computer” whether used alone or in combination with executable instructions stored in a memory or other computer-readable storage medium should be understood to encompass any type of now known or later developed computing devices and/or structures including but not limited to one or more microprocessors, special-purpose computer chips, field-programmable gate arrays (FPGAs), controllers, application-specific integrated circuits (ASICs), combinations of hardware/firmware/software, or other special or general-purpose processing circuitry.

The methods and features recited herein may further be implemented through any number of computer readable media that are able to store computer readable instructions. Examples of computer readable media that may be used include RAM, ROM, EEPROM, flash memory or other memory technology, CD-ROM, DVD or other optical disk storage, magnetic cassettes, magnetic tape, magnetic storage and the like.

Although specific examples of carrying out the invention have been described, those skilled in the art will appreciate that there are numerous variations and permutations of the above-described systems and methods.

What is claimed is:

1. A non-transitory computer-readable medium having instructions stored thereon that, when executed, cause a computing device to:
receive a selection of a website comprising one or more network documents;
determine a search engine ranking for the one or more network documents relative to a plurality of other network documents, wherein the search engine ranking for the one or more network documents is based on one or more search queries;
determine a plurality of sets of modifications to the one or more network documents for the selected web site;
determine a traffic potential for each of the plurality of sets of modifications to the one or more network documents;
based on the traffic potential for each of the plurality of sets of modifications, generate a recommendation for a first set of modifications to the one or more network documents selected from the plurality of sets of modifications; and
generate, for display on a display of a client device, the recommendation for the first set of modifications.

2. The non-transitory computer-readable medium of claim 1, having additional computer-readable instructions stored thereon that, when executed, cause the computing device to:
receive a selection of the recommendation for the first set of modifications; and
responsive to receiving the selection of the recommendation for the first set of modifications, apply the first set of modifications to the one or more network documents to generate a modified one or more network documents, and publishing the modified one or more network documents.

3. The non-transitory computer-readable medium of claim 1, wherein generating the recommendation for the first set of modifications to the one or more network documents is based on a ratio of an increase in a traffic metric for the one or more network documents to a number of modifications to the one or more network documents in the first set of modifications.

4. The non-transitory computer-readable medium of claim 1, wherein determining the traffic potential for each of the plurality of sets of modifications to the one or more network documents comprises, for each of the plurality of sets of modifications:
determining a first difference between a click through rate of the one or more network documents after applying the set of modifications to the one or more network documents and a click through rate of the one or more network documents before applying the set of modifications to the one or more network documents;
determining a second difference between a query score of the one or more network documents after applying the set of modifications to the one or more network documents and a query score of the one or more network documents before applying the set of modifications to the one or more network documents; and
determining the traffic potential based on the first difference and the second difference.

5. The non-transitory computer-readable medium of claim 1, wherein determining the traffic potential for each of the plurality of sets of modifications to the one or more network documents comprises, for each of the plurality of sets of modifications:
determining a search volume for the search query; and
determining the traffic potential based on the search volume for the search query.

6. The non-transitory computer-readable medium of claim 1, wherein determining the traffic potential for each of the plurality of sets of modifications to the one or more network documents comprises, for each of the plurality of sets of modifications:
receiving a user selection of a plurality of metrics for determining the traffic potential; and
determining the traffic potential for each of the plurality of sets of modifications to the one or more network documents based on the plurality of metrics.

7. A method comprising:
generating, by a computing device, a first score for a network document based on a search query;
determining, by the computing device, a plurality of modifications to the network document to generate a modified network document;
generating, by the computing device, a second score for the modified network document based on the search query;
determining, by the computing device, a traffic potential for the modified network document relative to the network document based on the first score for the network document and the second score for the modified network document; and
determining, by the computing device, to recommend to a user the plurality of modifications to the network document based on the traffic potential for the modified network document relative to the network document.

8. The method of claim 7, further comprising:
generating a displayable graphical user interface comprising an option to apply the plurality of modifications to the network document;
receiving a selection of the option to apply the plurality of modifications to the network document; and
responsive to receiving the selection of the option, applying, by the computing device, the plurality of modifications to the network document to generate the modified network document, and publishing the modified network document.

9. The method of claim 7, wherein determining the traffic potential for the modified network document comprises:
determining, by the computing device, a first difference between a click through rate of the modified network document and a click through rate of the network document;
determining, by the computing device, a second difference between the second score of the modified network document and the first score of the network document; and
determining, by the computing device, the traffic potential for the modified network document based on the first difference and the second difference.

10. The method of claim 7, wherein determining the traffic potential for the modified network document comprises:
determining a search volume for the search query; and
determining the traffic potential for the modified network document based on the search volume for the search query.

11. The method of claim 7, further comprising:
determining, by the computing device, an expected traffic potential for the modified network document based on the traffic potential for the modified network document and a potential traffic loss for the modified network document relative to the network document.

12. The method of claim 7, wherein:
the search query comprises a plurality of search queries,
generating the first score comprises generating the first score for the network document based on the plurality of search queries, and
generating the second score comprises generating the second score for the modified network document based on the plurality of search queries.

13. The method of claim 7, wherein the first score determines a ranking of the network document relative to a plurality of other network documents scored based on the search query.

14. The method of claim 7, wherein:
the first score is based on a plurality of factors comprising two or more of the following factors: a metadata title, a metadata description, a metadata keyword, a context associated with the network document, content of the network document, and a link structure of the network document, and
the second score is based on the same plurality of factors as the first score.

15. The method of claim 7, wherein the computing device comprises an optimization server configured to execute a simulated search engine, the method further comprising:
sending, by the optimization server and to a client device having a display, a graphical user interface comprising a recommendation to apply the plurality of modifications to the network document, wherein the graphical user interface is displayable on the display of the client device.

16. An apparatus, comprising:
a processor; and
memory storing computer-executable instructions that, when executed by the processor, cause the apparatus to:
generate a first score for a network document based on a search query;
determine a plurality of modifications to the network document to generate a modified network document;
generate a second score for the modified network document based on the search query;
determine a traffic potential for the modified network document relative to the network document based on the first score for the network document and the second score for the modified network document; and
determine to recommend to a user the plurality of modifications to the network document based on the traffic potential for the modified network document relative to the network document.

17. The apparatus of claim 16, wherein the memory stores additional computer-executable instructions that, when executed by the processor, cause the apparatus to:
generate a displayable graphical user interface comprising an option to apply the plurality of modifications to the network document;
receive a selection of the option to apply the plurality of modifications to the network document; and
responsive to receiving the selection of the option, apply the plurality of modifications to the network document to generate the modified network document, and publishing the modified network document.

18. The apparatus of claim 16, wherein determining the traffic potential for the modified network document comprises:
determining a first difference between a click through rate of the modified network document and a click through rate of the network document;
determining a second difference between the second score of the modified network document and the first score of the network document; and
determining the traffic potential for the modified network document based on the first difference and the second difference.

19. The apparatus of claim 16, wherein determining the traffic potential for the modified network document comprises:
determining a search volume for the search query; and
determining the traffic potential for the modified network document based on the search volume for the search query.

20. The apparatus of claim 16, wherein the memory stores additional computer-executable instructions that, when executed by the processor, cause the apparatus to:
determine an expected traffic potential for the modified network document based on the traffic potential for the modified network document and a potential traffic loss for the modified network document relative to the network document.

21. The apparatus of claim 16, wherein:
the search query comprises a plurality of search queries,
generating the first score comprises generating the first score for the network document based on the plurality of search queries, and
generating the second score comprises generating the second score for the modified network document based on the plurality of search queries.

22. The apparatus of claim 16, wherein the first score determines a ranking of the network document relative to a plurality of other network documents scored based on the search query.

23. The apparatus of claim 16, wherein:
the first score is based on a plurality of factors comprising two or more of the following factors: a metadata title, a metadata description, a metadata keyword, a context associated with the network document, content of the network document, and a link structure of the network document, and
the second score is based on the same plurality of factors as the first score.

24. The apparatus of claim 16, wherein the apparatus comprises an optimization server configured to execute a simulated search engine, and wherein the memory stores additional computer-executable instructions that, when executed by the processor, cause the apparatus to:
send, to a client device having a display, a graphical user interface comprising a recommendation to apply the plurality of modifications to the network document, wherein the graphical user interface is displayable on the display of the client device.

25. The apparatus of claim 16, wherein the search query comprises a plurality of keywords, and wherein the memory stores additional computer-executable instructions that, when executed by the processor, cause the apparatus to:
receive user input of the plurality of keywords, a search engine platform, and weights for a plurality of ranking factors,
wherein the traffic potential is determined based on the plurality of keywords, the search engine platform, and the weights for the plurality of ranking factors.

26. The apparatus of claim 16, wherein the memory stores additional computer-executable instructions that, when executed by the processor, cause the apparatus to:
generate a displayable graphical user interface comprising an actual link flow distribution for the network document and a target link flow distribution for the network document.

27. The apparatus of claim 16, wherein the memory stores additional computer-executable instructions that, when executed by the processor, cause the apparatus to:
generate a displayable graphical user interface comprising an estimate of a return on investment for the network document.

28. The apparatus of claim 16, wherein the memory stores additional computer-executable instructions that, when executed by the processor, cause the apparatus to:
generate a displayable graphical user interface comprising a breakdown of factors used to determine the first score for the network document or the second score for the modified network document.
